(19) United States
(12) Patent Application Publication
(10) Pub. No.: US 2026/0298518 A1
(43) Pub. Date: Oct. 1, 2026

(54) Cooling System and Respective Operation

(71) Applicants: Thermo Electron LED GmbH, Langenselbold (DE); Thermo Orion Inc., Chelmsford, MA (US)

(72) Inventors: Kai PEITZBERG, Osterode (DE); Markus TORNAU, Osterode (DE); Frederic KOCH, Osterode (DE); Kannan SRINIVASAN, Chelmsford, MA (US); Andreas VARCHMIN, Langenselbold (DE); Volker BEHRMANN, Langenselbold (DE)

(21) Appl. No.: 19/630,795

(22) Filed: Mar. 27, 2026

Related U.S. Application Data
(60) Provisional application No. 63/779,555, filed on Mar. 28, 2025.

(51) Int. Cl. F25B 49/02; B04B 15/02; F25B 39/02; F25B 41/31

(52) U.S. Cl. CPC F25B 49/022; B04B 15/02; F25B 39/02; F25B 41/31; F25B 2600/02; F25B 2600/2501

(57) ABSTRACT

The present invention relates to a method for operating a cooling system of a laboratory device, wherein the cooling system (4) comprises a compressor assembly, comprising at least a first compressor (30), a cooling device (32), an expansion device (34), and an evaporator (36), which are fluidly connected to form a main cycle, and wherein the cooling system further comprises a refrigerant circulating through the main cycle. The method comprises operating the compressor assembly based on a compressor control loop for controlling a compressor controlled variable x_{c}(t) based on a compressor reference variable w_{c}(t) and a compressor feedback variable r_{c}(t), and the method further comprises operating the expansion device based on a superheat control loop for controlling a superheat controlled variable xₛ(t) based on a superheat reference variable wₛ(t) and a superheat feedback variable rₛ(t).

### CROSS-REFERENCE TO RELATED APPLICATIONS

This application is a U.S. Nonprovisional Application which claims the benefit of U.S. Provisional Application No. 63/779,555 (titled “Cooling system and respective operation”) filed Mar. 28, 2025, the contents of which are hereby incorporated by reference for any and all purposes.

### TECHNICAL FIELD

Generally, the present invention may relate to a cooling system for cooling laboratory equipment and a respective operation and control thereof. In particular, the present invention may relate to a cooling system configured for cooling a centrifuge and/or may be controlled by a combination of different control loops.

The cooling system may generally allow to control a device temperature of the laboratory device and may particularly allow to control the temperature of a rotor chamber of a centrifuge. The cooling system may be compressor-based and it may be configured to use CO₂ as refrigerant. Control of the cooling system may be achieved by a combination of different control loops.

### BACKGROUND

Generally, laboratory devices such as centrifuges may use (one-staged) compressors (e.g. on/off types or frequency-controlled compressors) as part of the cooling system to control the device temperature, e.g. the temperature within the centrifuge chamber. For example, EP 2 814 617 B1 discloses a centrifuge having a compressor cooling device, as well as methods for controlling a compressor cooling device of a centrifuge. Said centrifuge has a controllable throttle device in the refrigeration cycle of the compressor cooling device. In particular, the temperature of the centrifuge rotor chamber is disclosed to be controlled via a frequency-controlled compressor (rough) and an electric stepper valve in a bypass bridging the condenser of the cooling system.

Generally, it may be desirable to use CO₂ as an refrigerant for the cooling system to avoid negative impacts on the environment. CO₂ is non-poisonous, non-flammable and colourless. Additionally, its global warming potential (GP) is 1 and it serves as reference for all other refrigerants, which typically have a GWP greater than 1 (e.g. R290 (Propane) has a GWP of 3).

Currently CO₂-cooling systems are used in refrigerated warehouses which are requiring a constant temperature without any dynamic range since for example door openings only have slight to no impact on the temperature of the refrigerated warehouse due to their size. That is, owing to the big thermal mass of a refrigerated warehouse, minor disturbances such as opening a door for accessing the warehouse may have a negligible effect on the temperature of the warehouse, such that no dynamic range may be needed for controlling the temperature to a constant value. This is typically different for smaller scale laboratory devices were accessing a temperature-controlled volume within the laboratory device may typically significantly alter the device temperature due to the impact of the ambient temperature. Similarly, internal processes of a laboratory device may generate different amounts of heat depending on parameters of the laboratory device. Thus, in general, controlling the (internal) device temperature of a laboratory device, e.g. the temperature within a chamber of a laboratory device, may require a control with high dynamic range to quickly counteract any disturbances to the system.

For example, in case of a centrifuge opening of the centrifuge may change the temperature of the rotor chamber significantly. Thus, a cooling system for a centrifuge may generally place much higher demands on the dynamics of the cooling system controls. The cooling system must guarantee stable sample temperatures throughout changes to rotor speeds and/or ambient temperatures, as well quickly adapt to different rotor chamber temperature setpoints and/or vacuum setpoints.

In light of the above, it is an object to overcome or at least alleviate the shortcomings and disadvantages of the prior art. More particularly, it may be an object of the present invention to provide a cooling system for a laboratory device and respective controls for the cooling system, which improve dynamic range and/or allow for a more stable control of the device temperature. Furthermore, it may be an object of the present invention to provide a CO₂-based cooling system.

### SUMMARY OF INVENTION

In a first aspect, the present invention relates to a cooling system of a laboratory device comprising a compressor assembly, comprising at least a first compressor, a cooling device, an expansion device, and an evaporator, which are fluidly connected to form a main cycle, and wherein the cooling system further comprises a refrigerant circulating through the main cycle.

The refrigerant may preferably be CO₂. CO₂ is advantageously non-poisonous, non-flammable and colourless and may allow to significantly reduce or even avoid negative impacts on the environment, particularly compared to other known coolants.

The cooling device may be located downstream of the compressor assembly and upstream of the expansion device.

The expansion device may be located downstream of the cooling device and upstream of the evaporator.

The evaporator may be located downstream of the expansion device and upstream of the compressor assembly.

The compressor assembly may be located downstream of the evaporator and upstream of the cooling device.

The system may further comprise a filter dryer, wherein the filter dryer may be located downstream of the cooling device and upstream of the expansion device.

The cooling device may comprise a gas cooler and/or condenser.

The cooling device may be configured to supply a fluid to remove heat from the refrigerant. Preferably the fluid may be ambient air.

The cooling device may comprise a fan for suppling ambient air to remove heat from the refrigerant.

The cooling system may be configured to perform a transcritical vapor compression cycle. Additionally or alternatively, the cooling system may be configured to perform a subcritical vapor compression cycle.

The expansion device may be an expansion valve. The expansion valve may be a control valve. In other words, the expansion valve may allow for controlling the fluid flow through the expansion valve through manipulation of an opening degree of the expansion valve. The expansion valve may be a driven control valve, preferably an electrically driven control valve. Preferably, the expansion valve may be an electric stepper motor valve.

The compressor assembly may comprise only the first compressor. Alternatively, the compressor assembly may comprise the first compressor and a second compressor which may be fluidly connected in series. This may advantageously allow to provide for a two-stage compression cycle, wherein the first compressor provides fluid at an intermediate pressure to the second compressor which subsequently provides the fluid at a final high pressure. The first compressor and the second compressor may be separate compressors operating independent of each other. In some embodiments, the first compressor and the second compressor may be comprised in a single housing. The first compressor and the second compressor may share a common drive configured to drive both compressors. The first compressor and the second compressor may be configured such that they achieve an approximately equal mass flow rate at the same rotational frequency. In particular, the displacement volume of the first compressor may be higher than the displacement volume of the second compressor.

The first compressor may be configured to provide refrigerant at its outlet with a first-stage pressure in the range of in the range of 20 bar to 70 bar, such as 25 bar to 55 bar, This pressure range may depend on environmental conditions, such as environmental temperature. Additionally or alternatively, the compressor assembly may be configured to provide refrigerant at its outlet with a high pressure in the range of in the range of 60 bar to 100 bar,. This pressure range may depend on environmental conditions, such as environmental temperature. It will be understood that the outlet of the pressure at the outlet of the compressor assembly corresponds to the pressure at the outlet of the first compressor in a single-stage compression setup (i.e. if the compressor assembly only comprises a single compressor and thus a single stage of compression) and to the outlet of the second compressor in a two-stage compression setup (i.e. if the compressor assembly comprises two compressors and thus two stages of compression).

The system may further comprise an intermediate-pressure accumulator, and a high-pressure control device, wherein the intermediate-pressure accumulator may be located upstream of the expansion device and downstream of the high-pressure control device, and wherein the high pressure-control device may be located downstream of the cooling device and optionally downstream of the filter dryer if present. The high-pressure control device may be configured to reduce a pressure of the refrigerant to an intermediate pressure. The intermediate pressure may be in the range of 20 bar to 70 bar, preferably 25 bar to 55 bar.

A first outlet of the intermediate-pressure accumulator may be fluidly connected to the expansion device, and configured to provide liquid refrigerant to the expansion device. A second outlet of the intermediate-pressure accumulator may be fluidly connected to a return section and configured to provide at least partially gaseous refrigerant to the return section. The return section may be fluidly connected to the main cycle upstream of the compressor assembly and downstream of the evaporator. Alternatively, in embodiments wherein the compressor assembly comprises the first compressor and the second compressor, the return section may be fluidly connected to the main cycle upstream of the second compressor and downstream of the first compressor. The return section may generally allow to suck cooled refrigerant in by the second compressor.

The high-pressure control device may be a capillary configured to provide a fixed flow of refrigerant, preferably optimized with respect to typical ambient temperature and/or applications. Alternatively, the high-pressure control device may be a high-pressure control valve. The high-pressure control valve may be a driven control valve, preferably an electrically driven control valve. Preferably, the high-pressure control valve may be an electric stepper motor valve.

The cooling system may comprise a hot-gas bypass comprising a bypass valve, wherein the hot-gas bypass fluidly connects to the main cycle at a connection point upstream of the cooling device and downstream of the compressor assembly, and at a connection point upstream of the evaporator and downstream of the expansion device. The hot-gas bypass may advantageously allow to heat refrigerant prior to providing it to the evaporator. This may advantageously allow for a better control of the cooling provided by the evaporator and may even allow to heat a portion of the laboratory device thermally coupled to the evaporator. The bypass valve may be a control valve. The bypass valve may be a driven control valve, preferably an electrically driven control valve. The bypass valve may preferably be an electric stepper motor valve.

The main cycle may comprise a high-pressure section between an outlet of the compressor assembly and either an inlet of the expansion device or, if present, an inlet of the high-pressure control device.

The main cycle may comprise a low-pressure section between an outlet of the expansion device and an inlet of the compressor assembly.

For embodiments comprising the intermediate-pressure accumulator and the high-pressure control device, the main cycle may comprise an intermediate-pressure section between an outlet of the high-pressure control device and an inlet of the expansion device.

The laboratory device may be a centrifuge. The evaporator may be configured to exchange heat with a centrifuge chamber.

The cooling system may further comprise a plurality of temperature and/or pressure sensors.

The system may comprise a suction-temperature sensor and/or a suction-pressure sensor located downstream of the evaporator and upstream of the compressor assembly. Generally, it will be understood that temperature and pressure sensors may be independent sensors or alternatively may also be provided as a combined pressure-temperature sensor.

The system may comprise a fluid-temperature sensor provided at or within the cooling device and configured to measure the temperature of the fluid provided to remove heat from the refrigerant.

The system may comprise an ambient-temperature sensor configured to measure the ambient temperature. In some embodiments the ambient-temperature sensor may also constitute the fluid-temperature sensor, particularly if the cooling device is air cooled.

The system may comprise a high-pressure sensor and/or a high-pressure temperature sensor located downstream of the cooling device and upstream of the expansion device, and, if present, optionally upstream of the high-pressure control device.

The system may comprise a low-temperature sensor located downstream of the expansion device and upstream of the evaporator.

The system may comprise a device-temperature sensor configured to sense a device temperature of the laboratory device. In embodiments, wherein the laboratory device is a centrifuge, the device temperature may be the temperature in the centrifuge chamber.

The system may comprise a controller configured to control operation of the cooling system. The controller is operatively coupled to the system components.

It will be understood that the controller being operatively coupled to a component comprises the controller being configured to exchange signals, such as data, triggers, etc. with said component, preferably over a wired connection. The controller can include a data processing unit and may be configured to control the cooling system and carry out particular method steps. The controller can send or receive electronic signals for instructions. The controller can also be referred to as a microprocessor. The controller can be contained on an integrated-circuit chip. The controller can include a processor with memory and associated circuits. A microprocessor is a computer processor that incorporates the functions of a central processing unit on a single integrated circuit (IC), or sometimes up to a plurality of integrated circuits, such as 8 integrated circuits. The microprocessor may be a multipurpose, clock driven, register based, digital integrated circuit that accepts binary data as input, processes it according to instructions stored in its memory and provides results (also in binary form) as output. Microprocessors may contain both combinational logic and sequential digital logic. Microprocessors operate on numbers and symbols represented in the binary number system.

In embodiments, wherein the main cycle comprises the intermediate-pressure section, the system may further comprise an intermediate-pressure switch located in the intermediate-pressure section and configured to initiate shutdown of the compressor assembly in case the intermediate pressure in the intermediate pressure section rises above an intermediate pressure threshold. In embodiments, wherein the system comprises the return section, the intermediate-pressure switch may preferably be located in the return section. The intermediate-pressure switch may be configured to cut power supplied to the compressor assembly when the intermediate pressure registered by the intermediate-pressure switch rises above the intermediate-pressure threshold. The intermediate-pressure threshold may be in the range of 80 to 95 bar, preferably in the range of 85 to 90 bar, such as 88 bar.

The system may further comprise a high-pressure switch configured to initiate shutdown of the compressor assembly in case the pressure downstream of the compressor assembly rises above a high-pressure threshold. In embodiments, wherein the main cycle comprises the high-pressure section, the high-pressure switch may preferably be located in the high-pressure section and configured to initiate shutdown of the compressor assembly in case the pressure in the high-pressure section rises above a high-pressure threshold. The high-pressure switch may preferably be located downstream of the compressor assembly and upstream of the cooling device. The high-pressure switch may be configured to cut power supplied to the compressor assembly when the pressure registered by the high-pressure switch rises above the high-pressure threshold. The high-pressure threshold may be in the range of 110 to 140 bar, preferably in the range of 120 to 130 bar.

The system may further comprise a temperature switch located downstream of the compressor assembly and upstream of the cooling device and configured to initiate shutdown of the compressor assembly in case the temperature downstream of the compressor assembly rises above a temperature threshold. The temperature switch may be configured to cut power supplied to the compressor assembly when the temperature registered by the temperature switch rises above the temperature threshold. The temperature threshold may be in the range of 110 to 130° C., preferably in the range of 115 to 125° C., such as 120° C.

In embodiments, wherein the system comprises the controller and the device-temperature sensor, the controller may be configured to shut down a drive of the laboratory device in case the device-temperature rises above a device-temperature threshold. The device-temperature threshold may be in the range of 40° C. to 100° C., preferably in the range of 50° C. to 80° C., more preferably in the range of 50° C. to 70° C., such as 60° C.

In another aspect the present invention relates to a laboratory device comprising a cooling system as described herein (for example above). The laboratory device may be a centrifuge. The laboratory device may comprise a centrifuge chamber to which the evaporator is thermally coupled. The centrifuge chamber may comprise a rotor. The device temperature may generally be the temperature in the centrifuge chamber.

In a further aspect the present invention relates to a method for operating a cooling system of a laboratory device, wherein the cooling system is a cooling system as described herein (e.g., above).

The method may comprise operating the compressor assembly based on a compressor control loop for controlling a compressor controlled variable x_{c}(t) based on a compressor reference variable w_{c}(t) and a compressor feedback variable r_{c}(t). Operating the compressor assembly comprises modifying the mass flow rate of the compressor assembly and/or any compressor comprised by the compressor assembly based on the compressor reference compressor variable w_{c}(t) and the compressor feedback variable r_{c}(t).

Additionally or alternatively, operating the compressor assembly may copmrise determining a compressor control variable u_{c}(t) based on a compressor error signal e_{c}(t) corresponding to the difference of the compressor reference variable w_{c}(t) and the compressor feedback variable r_{c}(t). Operating the compressor assembly may further comprise operating the compressor assembly based on the compressor control variable u_{c}(t). The compressor control variable u_{c}(t) may be determined such that the compressor controlled variable x_{c}(t) is stabilized to the compressor reference variable w_{c}(t). The compressor control variable u_{c}(t) of the compressor control loop may be indicative of at least one compressor frequency.

The compressor assembly may comprise the first compressor and a second compressor, which are fluidly connected in series, wherein the compressor frequency may be the same of the first compressor and the second compressor. Alternatively, the compressor assembly may comprise the first compressor and a second compressor, which are fluidly connected in series, wherein the compressor frequency of the first compressor and the compressor frequency of the second compressor may be different but at a fixed ratio such that it is sufficient for the compressor control variable to be indicative of a single compressor frequency. Alternatively, the compressor assembly may comprise the first compressor and a second compressor, which are fluidly connected in series, wherein the compressor control variable u_{c}(t) may be indicative of a designated compressor frequency for each, the first compressor and the second compressor.

The compressor control loop may be a closed control loop.

The compressor controlled variable x_{c}(t) may be a pressure in a low-pressure section of the system upstream of the compressor assembly and downstream of the expansion device, the compressor reference variable w_{c}(t) may be a target pressure for the low-pressure section, and the compressor feedback variable r_{c}(t) may be a current pressure of the low-pressure section.

The compressor controlled variable x_{c}(t) may be a suction pressure pₛ at the inlet of the compressor assembly, the compressor reference variable w_{c}(t) may be a target suction pressure p_{s,t}, and the compressor feedback variable r_{c}(t) may be a current suction pressure.

Alternatively, the compressor controlled variable x_{c}(t) may be a low pressure pₗ of the refrigerant upstream of the evaporator and downstream of the expansion device, the compressor reference variable w_{c}(t) may be a target low pressure p_{l,t}, and the compressor feedback variable r_{c}(t) may be a current low pressure measured upstream of the evaporator and downstream of the expansion device.

The target pressure of the low-pressure section, the target suction pressure p_{s,t} or the target low pressure pₗ may be determined based on a target device temperature T_{d} within the laboratory device.

Additionally or alternatively, the target pressure of the low-pressure section, the target suction pressure p_{s,t} or the target low pressure pₗ may be determined based on a current device temperature within the laboratory device.

Alternatively, the compressor controlled variable x_{c}(t) may a device temperature T_{d}, the compressor reference variable w_{c}(t) may be a target device temperature T_{d,t} within the laboratory device, and the compressor feedback variable r_{c}(t) may be a current device temperature within the laboratory device.

The cooling system may comprise the hot-gas bypass and the method may comprise operating the bypass valve based on a bypass control loop for controlling a bypass controlled variable x_{b}(t) based on a bypass reference variable w_{b}(t) and a bypass feedback variable r_{b}(t). Operating the bypass valve may comprise modifying an opening degree of the bypass valve based on the bypass reference variable w_{b}(t) and the bypass feedback variable r_{b}(t).

Operating the bypass valve may comprise determining a bypass control variable u_{b}(t) based on a bypass error signal e_{b}(t) corresponding to the difference of the bypass reference variable w_{b}(t) and the bypass feedback variable r_{b}(t). Operating the bypass valve may comprise operating the bypass valve based on the bypass control variable u_{b}(t). The bypass control variable u_{b}(t) may be determined such that the bypass controlled variable x_{b}(t) is stabilized to the bypass reference variable w_{b}(t). The bypass control variable u_{b}(t) of the bypass control loop may be indicative of an opening degree of the bypass valve.

The bypass control loop may be a closed control loop.

The bypass controlled variable x_{b}(t) may be a device temperature T_{d} within the laboratory device, the bypass reference variable w_{b}(t) may be a target device temperature T_{d,t} within the laboratory device, and the bypass feedback variable r_{b}(t) may be a current device temperature within the laboratory device.

Alternatively, the bypass controlled variable x_{b}(t) may be a pressure in a low-pressure section of the system upstream of the compressor assembly and downstream of the expansion device, the bypass reference variable w_{b}(t) may be a target pressure for the low-pressure section, and the bypass feedback variable r_{b}(t) may be a current pressure of the low-pressure section.

The bypass controlled variable x_{b}(t) may be a suction pressure pₛ at the inlet of the compressor assembly, the bypass reference variable w_{b}(t) may be a target suction pressure p_{s,t}, and the bypass feedback variable r_{b}(t) may be a current suction pressure.

Alternatively, the bypass controlled variable x_{b}(t) may be a low pressure pₗ of the refrigerant upstream of the evaporator and downstream of the expansion device, the bypass reference variable w_{b}(t) may be a target low pressure p_{l,t}, and the bypass feedback variable r_{b}(t) may be a current low pressure measured upstream of the evaporator and downstream of the expansion device.

The target pressure of the low-pressure section, the target suction pressure p_{s,t} or the target low pressure pₗ may be determined based on a target device temperature T_{d} within the laboratory device.

The target pressure of the low-pressure section, the target suction pressure p_{s,t} or the target low pressure pₗ may be determined based on a current device temperature within the laboratory device.

In embodiments where both are present, the method may comprise coupling the compressor control loop and the bypass control loop. These control loops may be coupled through determining one of the respective reference variables w(t) based on the feedback variable r(t) of the other control loop.

The compressor reference variable w_{c}(t) may be a target pressure of the low-pressure section, a target suction pressure p_{s,t} or a target low pressure pₗ, and the bypass reference variable w_{b}(t) may be a target device temperature T_{d,t} within the laboratory device, wherein the target pressure of the low-pressure section, the target suction pressure p_{s,t} or the target low pressure pₗ may be determined based on a current device temperature within the laboratory device which also serves as bypass feedback variable r_{b}(t).

Alternatively, the compressor reference variable w_{c}(t) may be a target device temperature T_{d,t} within the laboratory device, and the bypass reference variable w_{b}(t) may be a target pressure of the low-pressure section, a target suction pressure p_{s,t} or a target low pressure pₗ, wherein the target pressure of the low-pressure section, the target suction pressure p_{s,t} or the target low pressure pₗ may be determined based on a current device temperature within the laboratory device which also serves as compressor feedback variable r_{c}(t).

Alternatively, the compressor reference variable w_{c}(t) and the bypass reference variable w_{b}(t) may be a target pressure of the low-pressure section, a target suction pressure p_{s,t} or a target low pressure pₗ, wherein the target pressure of the low-pressure section, the target suction pressure p_{s,t} or the target low pressure pₗ may be determined based on a current device temperature within the laboratory device.

Alternatively, the compressor reference variable w_{c}(t) and the bypass reference variable w_{b}(t) may be a target device temperature T_{d,t} within the laboratory device.

The method may comprise operating the cooling device based on a cooling-device control loop for controlling a cooling-device controlled variable x_{g}(t) based on a cooling-device reference variable w_{g}(t) and a cooling-device feedback variable r_{g}(t). Operating the cooling device may comprise modifying the cooling power of the cooling device based on the cooling-device reference variable w_{g}(t) and the cooling-device feedback variable r_{g}(t).

Operating the cooling device may comprise determining a cooling-device control variable u_{g}(t) based on a cooling-device error signal e_{g}(t) corresponding to the difference of the cooling-device reference variable w_{g}(t) and the cooling-device feedback variable r_{g}(t). Further, operating the cooling-device may comprise operating the cooling-device based on the cooling-device control variable u_{g}(t).

The cooling-device control variable u_{g}(t) may be determined such that the cooling-device controlled variable x_{g}(t) is stabilized to the cooling-device reference variable w_{g}(t).

The cooling-device control variable u_{g}(t) of the cooling-device control loop may be indicative of a desired fluid supply to the cooling device for transporting heat away from the refrigerant.

The cooling device may comprise a fan for providing ambient air for transporting heat away from the refrigerant, wherein a cooling-device control variable u_{g}(t) may be indicative of the fan speed.

The cooling-device control loop may be a closed control loop.

The cooling-device controlled variable x_{g}(t) may be a high-pressure temperature of the refrigerant downstream of the cooling device and upstream of the expansion device and upstream of the high-pressure control valve, if present, the cooling-device reference variable w_{g}(t) may be a target high-pressure temperature (T_{h,t}) of the refrigerant, and the cooling-device feedback variable r_{g}(t) may be a current high-pressure temperature. The target high-pressure temperature T_{h,t} may depend on a current fluid temperature T_{f} of the fluid provided for transporting heat away from the refrigerant. The target high-pressure temperature may correspond to the current fluid temperature T_{f} of the fluid provided for transporting heat away from the refrigerant. Alternatively, the target high-pressure temperature may correspond to the current fluid temperature T_{f} plus an offset determined based on the current fluid temperature. Alternatively, the target high-pressure temperature may correspond to a pre-set value w₀, e.g. a typical desired high-pressure temperature of the refrigerant. Alternatively, the target high-pressure temperature may correspond to a pre-set value w₀, e.g. a typical desired high-pressure temperature of the refrigerant, plus an offset determined based on the current fluid temperature.

The current fluid temperature may correspond to the ambient temperature Tₐ.

The cooling system may comprise a high-pressure control valve and the method may comprise operating the high-pressure control valve based on a high-pressure control loop for controlling a high-pressure controlled variable xₕ(t) based on a high-pressure reference variable w_{b}(t) and a high-pressure feedback variable r_{b}(t). Operating the high-pressure control valve may comprise modifying an opening degree of the high-pressure control valve based on the high-pressure reference variable wₕ(t) and the high-pressure feedback variable r_{b}(t).

Operating the high-pressure control valve may comprise determining a high-pressure control variable uₕ(t) based on a high-pressure error signal eₕ(t) corresponding to the difference of the high-pressure reference variable wₕ(t) and the high-pressure feedback variable rₕ(t). Operating the high-pressure control valve may further comprise operating the high-pressure control valve based on the high-pressure control variable uₕ(t).

The high-pressure control variable uₕ(t) may be determined such that the high-pressure controlled variable xₕ(t) is stabilized to the high-pressure reference variable wₕ(t).

The high-pressure control variable uₕ(t) of the high-pressure control loop may be indicative of an opening degree of the high-pressure control valve.

The high-pressure control loop may be a closed control loop.

The high-pressure controlled variable xₕ(t) may be a high pressure pₕ of the refrigerant upstream of the high-pressure control valve and downstream of the cooling device, the high-pressure reference variable wₕ(t) may be a target high pressure pₕ, and the high-pressure feedback variable rₕ(t) may be a current high pressure. The target high pressure p_{h,t} may be determined based on the current high-pressure temperature of the refrigerant upstream of the high-pressure control valve and downstream of the cooling device. The target high pressure p_{h,t} may be continuously updated based on the current high-pressure temperature. It will be understood that continuously updating the high pressure p_{h,t} also refers to updating the target pressure p_{h,t} in short intervals, which may for example originate from measurement intervals of a sensor detecting the high-pressure temperature.

The method may comprise operating the expansion device based on a superheat control loop for controlling a superheat controlled variable xₛ(t) based on a superheat reference variable wₛ(t) and a superheat feedback variable rₛ(t). Operating the expansion device may comprise modifying an opening degree of the expansion device based on the superheat reference variable wₛ(t) and the superheat feedback variable rₛ(t).

Operating the expansion device may comprise determining a superheat control variable uₛ(t) based on a superheat error signal eₛ(t) corresponding to the difference of the superheat reference variable wₛ(t) and the superheat feedback variable rₛ(t). Operating the expansion device may further comprise operating the expansion device based on the superheat control variable uₛ(t).

The superheat control variable uₛ(t) may be determined such that the superheat controlled variable x_{c}(t) is stabilized to the superheat reference variable wₛ(t).

The superheat control variable u_{b}(t) of the superheat control loop may be indicative of an opening degree of the expansion device.

The superheat control loop may be a closed control loop.

The superheat controlled variable xₛ(t) may be a superheat SH across the evaporator, the superheat reference variable wₛ(t) may be a target superheat SHₜ, and the superheat feedback variable rₛ(t) may be a current superheat across the evaporator. The target superheat SHₜ may depend on operational parameters. The operational parameters may comprise an ambient temperature of the laboratory device. Additionaly or alternatively, the operational parameters may comprise a target sample temperature T_{p,t} for a sample handled by the laboratory device. The laboratory device may be a centrifuge and wherein the operational parameters may comprise a rotor type and/or a rotational frequency of the rotor.

The method may comprise determining a target device temperature T_{d,t} based on the operational parameters and wherein the target superheat may depend on the target device temperature.

The method may comprise determining the current superheat as a difference between a suction temperature Tₛ downstream of the evaporator and a low-pressure temperature Tₗ upstream of the evaporator. The method may comprise measuring the suction temperature Tₛ with a suction-temperature sensor. Additionally or alternatively, the method may comprise measuring the low-pressure temperature Tₗ with a low-pressure temperature sensor.

The method may comprise measuring a suction pressure downstream of the evaporator with a suction-pressure sensor and calculating the low-pressure temperature based on the suction pressure.

The method may comprise measuring a low pressure pₗ upstream of the evaporator with a low-pressure sensor and calculating the low-pressure temperature based on the low pressure.

The method may comprise determining an initial value for at least one actuator of a control loop. Determining an initial value for at least one actuator may comprise receiving operational parameters, determining, preferably automatically, the initial value for at least one actuator using a characteristic curve map to map at least some of the operational parameters to an initial value for the at least one actuator, and setting, preferably automatically, the at least one actuator to the respective initial value.

For example, the initial values for the actuators may be determined from test runs of the system. The system and its feedback loops may be operated in accordance with operational parameter values as boundary conditions until a steady sate condition is achieved. In the steady state, the actuators achieve a certain steady state position. Those steady state positions of the actuators are then used as initial values for the actuators for this particular set of operational parameters. This procedure is repeated for a value range for each of the operational parameters to generate the characteristic curve map of actuator initial values dependent on operational parameters. Results between tested operational parameters may be interpolated. That is, the characteristic curve map for the initial values(s) may be determined as described above.

The operational parameters may comprise an ambient temperature, a target device temperature and/or a target sample temperature. Additionally or alternatively, the laboratory device may be a centrifuge and the operational parameters may comprise a rotor type and/or a rotational frequency of the rotor. Additionally or alternatively, the laboratory device may be a vacuum centrifuge and the operational parameters may comprise a target vacuum pressure.

Receiving operational parameters may comprise a user providing at least one of the operational parameters to the cooling system. Additionally or alternatively, receiving operational parameters may comprise automatically determining at least one operational parameter.

In embodiments comprising operating the compressor assembly based on a compressor control loop, the at least one actuator may comprise the compressor assembly acting as actuator for the compressor control loop, and wherein the respective initial value may comprise at least one compressor frequency. The compressor assembly may comprise the first compressor and a second compressor and wherein the initial value may comprise an initial common compressor frequency, or an initial designated compressor frequency for each, the first compressor and the second compressor.

In embodiments comprising operating the bypass valve based on a bypass control loop, the at least one actuator may comprise the bypass valve acting as actuator for the bypass control loop, and wherein the respective initial value may comprise an initial opening degree for the bypass valve.

In embodiments comprising operating the expansion device based on a superheat control loop, the at least one actuator may comprise the expansion device acting as actuator for the superheat control loop, and wherein the respective initial value may comprise an initial opening degree for the expansion device.

In embodiments comprising operating the high-pressure control valve based on a high-pressure control loop, the at least one actuator may comprise the high-pressure control valve acting as actuator for the high-pressure control loop, and wherein the respective initial value may comprise an initial opening degree for the high-pressure control valve.

In embodiments comprising operating the cooling device based on a cooling-device control loop and wherein the cooling device comprises a fan, the at least one actuator may comprise the fan acting as actuator for the cooling-device control loop, and wherein the respective initial value may comprise an initial fan speed for the fan.

The characteristic curve map used may be actuator dependent.

The method may further comprise determining, preferably automatically, the target device temperature T_{t,d} based on operational parameters. The operational parameters comprise an ambient temperature and/or a target sample temperature. Additionally or alternatively, the laboratory device may be a centrifuge and the operational parameters may comprise a rotor type and/or a rotational frequency of the rotor. Additionally or alternatively, the laboratory device may be a vacuum centrifuge and the operational parameters may comprise a target vacuum pressure.

The method may comprise receiving operational parameters. Receiving operational parameters may comprise a user providing at least one of the operational parameters to the cooling system. Additionally or alternatively, receiving operational parameters may comprise automatically determining at least one operational parameter.

Determining the target device temperature T_{t,d} may comprise determining an amount of heat generated by the laboratory device during operation based on the operational parameters. Furthermore, determining the target device temperature T_{t,d} may comprise translating a target sample temperature into a target device temperature based on the amount of heat and the ambient temperature.

Determining of the target device temperature may be implemented using a characteristic curve map.

The step of determining the initial value for at least one actuator may comprise the step of determining the target device temperature T_{t,d}.

The method may comprises operating the high-pressure control valve and the expansion device independently from each other. Additionally or alternatively, the high-pressure control loop and the superheat control loop may be independent of each other.

The cooling system may comprise a main cycle comprising an intermediate-pressure section and the method may comprise shutting down the compressor assembly if an intermediate pressure in the intermediate pressure section rises above an intermediate pressure threshold. The shutting down may be initiated by an intermediate-pressure switch located in the intermediate-pressure section. The intermediate-pressure threshold may be in the range of 80 to 95 bar, preferably in the range of 85 to 90 bar, such as 88 bar.

The method may comprise shutting down the compressor assembly if the pressure downstream of the compressor assembly rises above a high-pressure threshold.

The cooling system may comprise a main cycle comprising a high-pressure section and the method may comprise shutting down the compressor assembly if the pressure in the high-pressure section rises above a high-pressure threshold. The shutting down may be initiated by a high-pressure switch located in the high-pressure section. Preferably, the shutting down may be initiated by a high-pressure switch located downstream of the compressor assembly and upstream of the cooling device. The high-pressure threshold may be in the range of 110 to 140 bar, preferably in the range of 120 to 130 bar.

The method may comprise shutting down the compressor assembly if a temperature downstream of the compressor assembly and upstream of the cooling device rises above a temperature threshold. The shutting down may be initiated by a temperature switch located downstream of the compressor assembly and upstream of the cooling device. The temperature threshold may be in the range of 110 to 130° C., preferably in the range of 115 to 125° C., such as 120° C.

The method may comprise shutting down a drive of the laboratory device in case a device-temperature rises above a device-temperature threshold. The method may comprise monitoring the device-temperature with a device-temperature sensor and shutting down a drive of the laboratory device in case a device temperature rises above a drive-temperature threshold. The device-temperature threshold may be in the range of 40° C. to 100° C., preferably in the range of 50° C. to 80° C., more preferably in the range of 50° C. to 70° C., such as 60° C.

The cooling system as described herein (e.g. above) may be configured to perform the method as described herein (e.g. above).

The controller of the cooling system described herein may be configured to perform the method as described herein (e.g. above).

The controller of the herein described cooling system may also serve as controller for the compressor control loop.

The controller of the herein described cooling system may also serve as controller for the bypass control loop.

The controller of the herein described cooling system may also serve as controller for the cooling-device control loop.

The controller of the herein described cooling system may also serve as controller for the high-pressure control loop.

The controller of the herein described cooling system may also serve as controller for the superheat control loop.

Below, reference will be made to cooling system embodiments. These embodiments are abbreviated by the letter “S” followed by a number. Whenever reference is herein made to “system embodiments”, these embodiments are meant.

1. Cooling system (3,4) of a laboratory device comprising
a compressor assembly, comprising at least a first compressor (30),
a cooling device (32),
an expansion device (34), and
an evaporator (36),
which are fluidly connected to form a main cycle, and
wherein the cooling system further comprises a refrigerant circulating through the main cycle.

S2. The cooling system according to the preceding system embodiment, wherein the refrigerant is CO₂.

S3. The cooling system according to any of the preceding system embodiments, wherein the cooling device is located downstream of the compressor assembly and upstream of the expansion device.

S4. The cooling system according to any of the preceding system embodiments, wherein the expansion device is located downstream of the cooling device and upstream of the evaporator.

S5. The cooling system according to any of the preceding system embodiments, wherein the evaporator is located downstream of the expansion device and upstream of the compressor assembly.

S6. The cooling system according to any of the preceding system embodiments, wherein the compressor assembly is located downstream of the evaporator and upstream of the cooling device.

S7. The cooling system according to any of the preceding system embodiments, further comprising a filter dryer (38), wherein the filter dryer is located downstream of the cooling device and upstream of the expansion device.

S8. The cooling system according to any of the preceding system embodiments, wherein the cooling device comprises a gas cooler and/or condenser.

S9. The cooling system according to any of the preceding system embodiments, wherein the cooling device is configured to supply a fluid to remove heat from the refrigerant.

S10. The cooling system according to any of the preceding system embodiments, wherein the cooling device comprises a fan for suppling ambient air to remove heat from the refrigerant.

S11. The cooling system according to any of the preceding system embodiments, wherein the cooling system is configured to perform a transcritical vapor compression cycle.

S12. The cooling system according to any of the preceding system embodiments, wherein the cooling system is configured to perform a subcritical vapor compression cycle.

S13. The cooling system according to any of the preceding system embodiments, wherein expansion device is an expansion valve.

S14. The cooling system according to the preceding system embodiment, wherein the expansion valve is a control valve.

S15. The cooling system according to any of the 2 preceding system embodiments, wherein the expansion valve is a driven control valve, preferably an electrically driven control valve.

S16. The cooling system according to any of the 3 preceding system embodiments, wherein the expansion valve is an electric stepper motor valve.

S17. The colling system according to any of the preceding system embodiments, wherein the compressor assembly comprises only the first compressor.

S18. The colling system according to any of the preceding system embodiments, wherein the compressor assembly comprises the first compressor (30) and a second compressor (31) which are fluidly connected in series.

S19. The cooling system according to the preceding system embodiment, wherein the first compressor and the second compressor are separate compressors operating independent of each other.

S20. The cooling system according to any of the 2 preceding system embodiments, wherein the first compressor and the second compressor are comprised in a single housing.

S21. The cooling system according to S18 or S20, wherein the first compressor and the second compressor share a common drive configured to drive both compressors.

S22. The cooling system according to any of the 4 preceding system embodiments, wherein the first compressor and the second compressor are configured such that they achieve an approximately equal mass flow rate at the same rotational frequency.

In particular, the displacement volume of the first compressor may be higher than the displacement volume of the second compressor.

S23. The cooling system according to any of the 5 preceding system embodiments, wherein the first compressor is configured to provide refrigerant at its outlet with a first-stage pressure in the range of 20 bar to 70 bar, preferably 25 bar to 55 bar.

S24. The cooling system according to any of the preceding system embodiments, wherein the compressor assembly is configured to provide refrigerant at its outlet with a high pressure in the range of in the range of 60 bar to 100 bar.

It will be understood that the outlet of the pressure at the outlet of the compressor assembly corresponds to the pressure at the outlet of the first compressor in a single-stage compression setup (i.e. if the compressor assembly only comprises a single compressor and thus a single stage of compression) and to the outlet of the second compressor in a two-stage compression setup (i.e. if the compressor assembly comprises two compressors and thus two stages of compression).

S25. The cooling system according to any of the preceding system embodiments, wherein the system further comprises:
an intermediate-pressure accumulator (44), and
a high-pressure control device (42),
wherein the intermediate-pressure accumulator is located upstream of the expansion device and downstream of the high-pressure control device, and
wherein the high pressure-control device is located downstream of the cooling device and optionally downstream of the filter dryer if present.

S26. The cooling system according to the preceding system embodiment, wherein the high-pressure control device is configured to reduce a pressure of the refrigerant to an intermediate pressure.

S27. The cooling system according to the preceding system embodiment, wherein the intermediate pressure is in the range of 20 to 70 bar, preferably 25 bar to 55 bar.

S28. The cooling system according to any of the 3 preceding system embodiments, wherein a first outlet of the intermediate-pressure accumulator is fluidly connected to the expansion device, and configured to provide liquid refrigerant to the expansion device.

S29. The cooling system according to any of the 4 preceding system embodiments, wherein a second outlet of the intermediate-pressure accumulator is fluidly connected to a return section (49) and configured to provide at least partially gaseous refrigerant to the return section.

S30. The cooling system according to the preceding system embodiment, wherein the return section is fluidly connected to the main cycle upstream of the compressor assembly and downstream of the evaporator.

S31. The cooling system according to the penultimate system embodiment and with the features of S18, wherein the return section is fluidly connected to the main cycle upstream of the second compressor and downstream of the first compressor.

S32. The cooling system according to any of the 7 preceding system embodiments, wherein the high-pressure control device is a capillary configured to provide a fixed flow of refrigerant, preferably optimized with respect to typical ambient temperature and/or applications.

S33. The cooling system according to any of the 8 preceding system embodiments, wherein the high-pressure control device is a high-pressure control valve.

S34. The cooling system according to the preceding system embodiments, wherein the high-pressure control valve is a driven control valve, preferably an electrically driven control valve.

S35. The cooling system according to any of the 2 preceding system embodiments, wherein the high-pressure control valve is an electric stepper motor valve.

S36. The cooling system according to any of the preceding system embodiments, wherein the cooling system comprises a hot-gas bypass (46) comprising a bypass valve (47), wherein the hot-gas bypass fluidly connects to the main cycle at a connection point upstream of the cooling device and downstream of the compressor assembly, and at a connection point upstream of the evaporator and downstream of the expansion device.

S37. The cooling system according to the preceding system embodiment, wherein the bypass valve is a control valve.

S38. The cooling system according to any of the 2 preceding system embodiments, wherein the bypass valve is a driven control valve, preferably an electrically driven control valve.

S39. The cooling system according to any of the 3 preceding system embodiments, wherein the bypass valve is an electric stepper motor valve.

S40. The cooling system according to any of the preceding system embodiments, wherein the main cycle comprises a high-pressure section between an outlet of the compressor assembly and either an inlet of the expansion device or, if present, an inlet of the high-pressure control device.

S41. The cooling system according to any of the preceding system embodiments, wherein the main cycle comprises a low-pressure section between an outlet of the expansion device and an inlet of the compressor assembly.

S42. The cooling system according to any of the preceding system embodiments and with the features of S25, wherein the main cycle comprises an intermediate-pressure section between an outlet of the high-pressure control device and an inlet of the expansion device.

S43. The cooling system according to any of the preceding system embodiments, wherein the laboratory device is a centrifuge.

S44. The cooling system according to the preceding system embodiment, wherein the evaporator is configured to exchange heat with a centrifuge chamber.

S45. The cooling system according to any of the preceding system embodiments, wherein the cooling system further comprises a plurality of temperature and/or pressure sensors (48).

S46. The cooling system according to any of the preceding system embodiments, wherein the system further comprises a suction-temperature sensor (48-Tₛ) and/or a suction-pressure sensor (48-pₛ) located downstream of the evaporator and upstream of the compressor assembly.

Generally, it will be understood that temperature and pressure sensors may be independent sensors or alternatively may also be provided as a combined pressure-temperature sensor.

S47. The cooling system according to any of the preceding system embodiments, wherein the system further comprises a fluid-temperature sensor (48-T_{f}) provided at or within the cooling device and configured to measure the temperature of the fluid provided to remove heat from the refrigerant.

S48. The cooling system according to any of the preceding system embodiments, wherein the system further comprises an ambient-temperature sensor (48-Tₐ) configured to measure the ambient temperature.

In some embodiments the ambient-temperature sensor may also constitute the fluid-temperature sensor, particularly if the cooling device is air cooled.

S49. The cooling system according to any of the preceding system embodiments, wherein the system further comprises a high-pressure sensor (48-pₕ) and/or a high-pressure temperature sensor (48-Tₕ) located downstream of the cooling device and upstream of the expansion device, and, if present, optionally upstream of the high-pressure control device.

S50. The cooling system according to any of the preceding system embodiments, wherein the system further comprises a low-temperature sensor (48-Tₗ) located downstream of the expansion device and upstream of the evaporator.

S51. The cooling system according to any of the preceding system embodiments, wherein the system further comprises a device-temperature sensor (48-T_{d}) configured to sense a device temperature of the laboratory device.

S52. The cooling system according to the preceding system embodiment and with the features of S44, wherein the device temperature is the temperature in the centrifuge chamber.

S53. The cooling system according to any of the preceding system embodiments, wherein the system comprises a controller (50) configured to control operation of the cooling system.

S54. The cooling system according to the preceding system embodiment, wherein the controller is operatively coupled to the system components.

It will be understood that the controller being operatively coupled to a component comprises the controller being configured to exchange signals, such as data, triggers, etc. with said component, preferably over a wired connection.

S55. The cooling system according to any of the preceding system embodiments and with the features of S42, wherein the system further comprises an intermediate-pressure switch (52-pᵢ) located in the intermediate-pressure section and configured to initiate shutdown of the compressor assembly in case the intermediate pressure in the intermediate pressure section rises above an intermediate pressure threshold.

S56. The cooling system according to the preceding system embodiment and with the features of S29, wherein the intermediate-pressure switch is located in the return section.

S57. The cooling system according to any of the 2 preceding system embodiments, wherein the intermediate-pressure switch is configured to cut power supplied to the compressor assembly when the intermediate pressure registered by the intermediate-pressure switch rises above the intermediate-pressure threshold.

S58. The cooling system according to any of the 3 preceding system embodiments, wherein the intermediate-pressure threshold is in the range of 80 to 95 bar, preferably in the range of 85 to 90 bar, such as 88 bar.

S59. The cooling system according to any of the preceding system embodiment, wherein the system further comprises a high-pressure switch (52-pₕ) configured to initiate shutdown of the compressor assembly in case the pressure downstream of the compressor assembly rises above a high-pressure threshold.

S60. The cooling system according to any of the preceding system embodiments and with the features of S40, wherein the high-pressure switch is located in the high-pressure section and configured to initiate shutdown of the compressor assembly in case the pressure in the high-pressure section rises above a high-pressure threshold.

S61. The cooling system according to any of the 2 preceding system embodiments, wherein the high-pressure switch is located downstream of the compressor assembly and upstream of the cooling device.

S62. The cooling system according to any of the 3 preceding system embodiments, wherein the high-pressure switch is configured to cut power supplied to the compressor assembly when the pressure registered by the high-pressure switch rises above the high-pressure threshold.

S63. The cooling system according to any of the 4 preceding system embodiments, wherein the high-pressure threshold is in the range of 110 to 140 bar, preferably in the range of 120 to 130 bar.

S64. The cooling system according to any of the preceding system embodiments, wherein the system further comprises a temperature switch (52-T) located downstream of the compressor assembly and upstream of the cooling device and configured to initiate shutdown of the compressor assembly in case the temperature downstream of the compressor assembly rises above a temperature threshold.

S65. The cooling system according to the preceding system embodiment, wherein the temperature switch is configured to cut power supplied to the compressor assembly when the temperature registered by the temperature switch rises above the temperature threshold.

S66. The cooling system according to any of the 2 preceding system embodiments, wherein the temperature threshold is in the range of 110 to 130° C., preferably in the range of 115 to 125° C., such as 120° C.

S67. The cooling system according to any of the preceding system embodiments and with the features of S51 and S53, wherein the controller is configured to shut down a drive of the laboratory device in case the device-temperature rises above a device-temperature threshold.

S68. The cooling system according to the preceding system embodiment, wherein the device-temperature threshold is in the range of 40° C. to 100° C., preferably in the range of 50° C. to 80° C., more preferably in the range of 50° C. to 70° C., such as 60° C.

Below, reference will be made to laboratory device embodiments. These embodiments are abbreviated by the letter “D” followed by a number. Whenever reference is herein made to “device embodiments”, these embodiments are meant.

L1. Laboratory device comprising a cooling system according to any of the preceding system embodiments.

L2. Laboratory device according to the preceding device embodiment, wherein the laboratory device is a centrifuge.

L3. Laboratory device according to any of the 3 preceding device embodiments, wherein the laboratory device comprises a centrifuge chamber to which the evaporator is thermally coupled.

L4. Laboratory device according to the preceding device embodiment, wherein the centrifuge chamber comprises a rotor.

L5. Laboratory device according to any of the 2 preceding device embodiments and with the features of S44, wherein the device temperature is the temperature in the centrifuge chamber.

Below, reference will be made to method embodiments. These embodiments are abbreviated by the letter “M” followed by a number. Whenever reference is herein made to “method embodiments”, these embodiments are meant.

M1. Method for operating a cooling system of a laboratory device, wherein the cooling system is a cooling system according to any of the preceding system embodiments.

M2. Method according to the preceding method embodiment, the method comprising operating the compressor assembly based on a compressor control loop for controlling a compressor controlled variable x_{c}(t) based on a compressor reference variable w_{c}(t) and a compressor feedback variable r_{c}(t).

M3. Method according to the preceding method embodiment, wherein operating the compressor assembly comprises modifying the mass flow rate of the compressor assembly and/or any compressor comprised by the compressor assembly based on the compressor reference compressor variable w_{c}(t) and the compressor feedback variable r_{c}(t).

M4. Method according to any of the 2 preceding method embodiments, wherein operating the compressor assembly comprises determining a compressor control variable u_{c}(t) based on a compressor error signal e_{c}(t) corresponding to the difference of the compressor reference variable w_{c}(t) and the compressor feedback variable r_{c}(t).

M5. Method according to the preceding method embodiment, wherein operating the compressor assembly further comprises operating the compressor assembly based on the compressor control variable u_{c}(t).

M6. Method according to any of the 2 preceding method embodiments, wherein the compressor control variable u_{c}(t) is determined such that the compressor controlled variable x_{c}(t) is stabilized to the compressor reference variable w_{c}(t).

M7. Method according to any of the 3 preceding method embodiments, wherein the compressor control variable u_{c}(t) of the compressor control loop is indicative of at least one compressor frequency.

M8. Method according to the preceding method embodiment, wherein the compressor assembly comprises a first compressor and a second compressor, which are fluidly connected in series, wherein the compressor frequency is the same of the first compressor and the second compressor.

M9. Method according to the penultimate method embodiment, wherein the compressor assembly comprises a first compressor and a second compressor, which are fluidly connected in series, wherein the compressor frequency of the first compressor and the compressor frequency of the second compressor are different but at a fixed ratio such that it is sufficient for the compressor control variable to be indicative of a single compressor frequency.

M10. Method according to M4, wherein the compressor assembly comprises a first compressor and a second compressor, which are fluidly connected in series, wherein the compressor control variable u_{c}(t) is indicative of a designated compressor frequency for each, the first compressor and the second compressor.

M11. Method according to any of the 9 preceding method embodiments, wherein the compressor control loop is a closed control loop.

M12. Method according to any of the 10 preceding method embodiments, wherein
the compressor controlled variable x_{c}(t) is a pressure in a low-pressure section of the system upstream of the compressor assembly and downstream of the expansion device,
the compressor reference variable w_{c}(t) is a target pressure for the low-pressure section, and
the compressor feedback variable r_{c}(t) is a current pressure of the low-pressure section.

M13. Method according to any of the 11 preceding method embodiments, wherein
the compressor controlled variable x_{c}(t) is a suction pressure pₛ at the inlet of the compressor assembly,
the compressor reference variable w_{c}(t) is a target suction pressure p_{s,t}, and
the compressor feedback variable r_{c}(t) is a current suction pressure.

M14. Method according to M2 to M13, wherein
the compressor controlled variable x_{c}(t) is a low pressure pₗ of the refrigerant upstream of the evaporator and downstream of the expansion device,
the compressor reference variable w_{c}(t) is a target low pressure p_{l,t}, and
the compressor feedback variable r_{c}(t) is a current low pressure measured upstream of the evaporator and downstream of the expansion device.

M15. Method according to any of the 3 preceding method embodiments, wherein the target pressure of the low-pressure section, the target suction pressure p_{s,t} or the target low pressure pₗ is determined based on a target device temperature T_{d} within the laboratory device.

M16. Method according to any of the 4 preceding method embodiment, wherein the target pressure of the low-pressure section, the target suction pressure p_{s,t} or the target low pressure pₗ is determined based on a current device temperature within the laboratory device.

M17. Method according to any of method embodiments M2 to M11, wherein
the compressor controlled variable x_{c}(t) is a device temperature T_{d},
the compressor reference variable w_{c}(t) is a target device temperature T_{d,t} within the laboratory device, and
the compressor feedback variable r_{c}(t) is a current device temperature within the laboratory device.

M18. Method according to any of the preceding method embodiments, wherein the cooling system comprises the features of system embodiment S36, wherein the method comprises operating the bypass valve based on a bypass control loop for controlling a bypass controlled variable x_{b}(t) based on a bypass reference variable w_{b}(t) and a bypass feedback variable r_{b}(t).

M19. Method according to the preceding method embodiment, wherein operating the bypass valve comprises modifying an opening degree of the bypass valve based on the bypass reference variable w_{b}(t) and the bypass feedback variable r_{b}(t).

M20. Method according to any of the 2 preceding method embodiments, wherein operating the bypass valve comprises determining a bypass control variable u_{b}(t) based on a bypass error signal e_{b}(t) corresponding to the difference of the bypass reference variable w_{b}(t) and the bypass feedback variable r_{b}(t).

M21. Method according to the preceding method embodiment, wherein operating the bypass valve further comprises operating the bypass valve based on the bypass control variable u_{b}(t).

M22. Method according to any of the 2 preceding method embodiments, wherein the bypass control variable u_{b}(t) is determined such that the bypass controlled variable x_{b}(t) is stabilized to the bypass reference variable w_{b}(t).

M23. Method according to any of the 3 preceding method embodiments, wherein the bypass control variable u_{b}(t) of the bypass control loop is indicative of an opening degree of the bypass valve.

M24. Method according to any of the 6 preceding method embodiments, wherein the bypass control loop is a closed control loop.

M25. Method according to any of the 7 preceding method embodiments, wherein
the bypass controlled variable x_{b}(t) is a device temperature T_{d} within the laboratory device,
the bypass reference variable w_{b}(t) is a target device temperature T_{d,t} within the laboratory device, and
the bypass feedback variable r_{b}(t) is a current device temperature within the laboratory device.

M26. Method according to any of M18 to M24, wherein
the bypass controlled variable x_{b}(t) is a pressure in a low-pressure section of the system upstream of the compressor assembly and downstream of the expansion device,
the bypass reference variable w_{b}(t) is a target pressure for the low-pressure section, and
the bypass feedback variable r_{b}(t) is a current pressure of the low-pressure section.

M27. Method according to any of M18 to M24, or M26, wherein
the bypass controlled variable x_{b}(t) is a suction pressure pₛ at the inlet of the compressor assembly,
the bypass reference variable w_{b}(t) is a target suction pressure p_{s,t}, and
the bypass feedback variable r_{b}(t) is a current suction pressure.

M28. Method according to any of M18 to M24, or M26, wherein
the bypass controlled variable x_{b}(t) is a low pressure pₗ of the refrigerant upstream of the evaporator and downstream of the expansion device,
the bypass reference variable w_{b}(t) is a target low pressure p_{l,t}, and
the bypass feedback variable r_{b}(t) is a current low pressure measured upstream of the evaporator and downstream of the expansion device.

M29. Method according to any of the 3 preceding method embodiments, wherein the target pressure of the low-pressure section, the target suction pressure p_{s,t} or the target low pressure pₗ is determined based on a target device temperature T_{d} within the laboratory device.

M30. Method according to any of the 4 preceding method embodiment, wherein the target pressure of the low-pressure section, the target suction pressure p_{s,t} or the target low pressure pₗ is determined based on a current device temperature within the laboratory device.

M31. Method according to any of the preceding method embodiments and with the features of M2 and M18, wherein the method comprises coupling the compressor control loop and the bypass control loop.

M32. Method according to the preceding method embodiment, wherein the control loops are coupled through determining one of the respective reference variables w(t) based on the feedback variable r(t) of the other control loop.

M33. Method according to any of the 2 preceding method embodiments, wherein
the compressor reference variable w_{c}(t) is a target pressure of the low-pressure section, a target suction pressure p_{s,t} or a target low pressure pₗ, and
the bypass reference variable w_{b}(t) is a target device temperature T_{d,t} within the laboratory device,
wherein the target pressure of the low-pressure section, the target suction pressure p_{s,t} or the target low pressure pₗ is determined based on a current device temperature within the laboratory device which also serves as bypass feedback variable r_{b}(t).

M34. Method according to any of M31 or M32, wherein
the compressor reference variable w_{c}(t) is a target device temperature T_{d,t} within the laboratory device, and
the bypass reference variable w_{b}(t) is a target pressure of the low-pressure section, a target suction pressure p_{s,t} or a target low pressure pₗ,
wherein the target pressure of the low-pressure section, the target suction pressure p_{s,t} or the target low pressure pₗ is determined based on a current device temperature within the laboratory device which also serves as compressor feedback variable r_{c}(t).

M35. Method according to any of M31 or M32, wherein
the compressor reference variable w_{c}(t) and the bypass reference variable w_{b}(t) are a target pressure of the low-pressure section, a target suction pressure p_{s,t} or a target low pressure pₗ,
wherein the target pressure of the low-pressure section, the target suction pressure p_{s,t} or the target low pressure pₗ is determined based on a current device temperature within the laboratory device.

M36. Method according to M31, wherein
the compressor reference variable w_{c}(t) and the bypass reference variable w_{b}(t) are a target device temperature T_{d,t} within the laboratory device.

M37. Method according to any of the preceding method embodiments, wherein the method comprises operating the cooling device based on a cooling-device control loop for controlling a cooling-device controlled variable x_{g}(t) based on a cooling-device reference variable w_{g}(t) and a cooling-device feedback variable r_{g}(t).

M38. Method according to the preceding method embodiment, wherein operating the cooling device comprises modifying the cooling power of the cooling device based on the cooling-device reference variable w_{g}(t) and the cooling-device feedback variable r_{g}(t).

M39. Method according to any of the 2 preceding method embodiments, wherein operating the cooling device comprises determining a cooling-device control variable u_{g}(t) based on a cooling-device error signal e_{g}(t) corresponding to the difference of the cooling-device reference variable w_{g}(t) and the cooling-device feedback variable r_{g}(t).

M40. Method according to the preceding method embodiment, wherein operating the cooling-device further comprises operating the cooling-device based on the cooling-device control variable u_{g}(t).

M41. Method according to any of the 2 preceding method embodiments, wherein the cooling-device control variable u_{g}(t) is determined such that the cooling-device controlled variable x_{g}(t) is stabilized to the cooling-device reference variable w_{g}(t).

M42. Method according to any of the 3 preceding method embodiments, wherein the cooling-device control variable u_{g}(t) of the cooling-device control loop is indicative of a desired fluid supply to the cooling device for transporting heat away from the refrigerant.

M43. Method according to any of the 4 preceding method embodiments, wherein the cooling device comprises a fan for providing ambient air for transporting heat away from the refrigerant, wherein a cooling-device control variable u_{g}(t) is indicative of the fan speed.

M44. Method according to any of the 7 preceding method embodiments, wherein the cooling-device control loop is a closed control loop.

M45. Method according to any of the 8 preceding method embodiments, wherein
the cooling-device controlled variable x_{g}(t) is a high-pressure temperature of the refrigerant downstream of the cooling device and upstream of the expansion device and upstream of the high-pressure control valve, if present,
the cooling-device reference variable w_{g}(t) is a target high-pressure temperature (T_{h,t}) of the refrigerant, and
the cooling-device feedback variable r_{g}(t) is a current high-pressure temperature.

M46. Method according to the preceding method embodiment, wherein the target high-pressure temperature T_{h,t} depends on a current fluid temperature T_{f} of the fluid provided for transporting heat away from the refrigerant.

M47. Method according to any of the 2 preceding method embodiments, wherein the target high-pressure temperature corresponds to the current fluid temperature T_{f} of the fluid provided for transporting heat away from the refrigerant.

M48. Method according to M45 or M46, wherein the target high-pressure temperature corresponds to the current fluid temperature T_{f} plus an offset determined based on the current fluid temperature.

M48a. Method according to M45 or M46, wherein the target high-pressure temperature corresponds to a pre-set value w₀, e.g. a typical desired high-pressure temperature of the refrigerant.

M48b. Method according to M45 or M46, wherein the target high-pressure temperature corresponds to a pre-set value w₀, e.g. a typical desired high-pressure temperature of the refrigerant, plus an offset determined based on the current fluid temperature.

M49. Method according to any of the 3 preceding method embodiments, wherein the current fluid temperature corresponds to the ambient temperature Tₐ.

M50. Method according to any of the preceding method embodiments, wherein the cooling system comprises the features of S33 wherein the method comprises operating the high-pressure control valve based on a high-pressure control loop for controlling a high-pressure controlled variable xₕ(t) based on a high-pressure reference variable w_{b}(t) and a high-pressure feedback variable r_{b}(t).

M51. Method according to the preceding method embodiment, wherein operating the high-pressure control valve comprises modifying an opening degree of the high-pressure control valve based on the high-pressure reference variable wₕ(t) and the high-pressure feedback variable r_{b}(t).

M52. Method according to any of the 2 preceding method embodiments, wherein operating the high-pressure control valve comprises determining a high-pressure control variable uₕ(t) based on a high-pressure error signal eₕ(t) corresponding to the difference of the high-pressure reference variable wₕ(t) and the high-pressure feedback variable rₕ(t).

M53. Method according to the preceding method embodiment, wherein operating the high-pressure control valve further comprises operating the high-pressure control valve based on the high-pressure control variable uₕ(t).

M54. Method according to any of the 2 preceding method embodiments, wherein the high-pressure control variable uₕ(t) is determined such that the high-pressure controlled variable xₕ(t) is stabilized to the high-pressure reference variable wₕ(t).

M55. Method according to any of the 3 preceding method embodiments, wherein the high-pressure control variable uₕ(t) of the high-pressure control loop is indicative of an opening degree of the high-pressure control valve.

M56. Method according to any of the 6 preceding method embodiments, wherein the high-pressure control loop is a closed control loop.

M57. Method according to any of the 7 preceding method embodiments, wherein
the high-pressure controlled variable xₕ(t) is a high pressure pₕ of the refrigerant upstream of the high-pressure control valve and downstream of the cooling device,
the high-pressure reference variable wₕ(t) is a target high pressure pₕ, and
the high-pressure feedback variable rₕ(t) is a current high pressure.

M58. Method according to the preceding method embodiment, wherein the target high pressure p_{h,t} is determined based on the current high-pressure temperature of the refrigerant upstream of the high-pressure control valve and downstream of the cooling device.

M58a. Method according to the preceding method embodiment, wherein the target high pressure p_{h,t} is continuously updated based on the current high-pressure temperature.

It will be understood that continuously updating the high pressure p_{h,t} also refers to updating the target pressure p_{h,t} in short intervals, which may for example originate from measurement intervals of a sensor detecting the high-pressure temperature.

M59. Method according to any of the preceding method embodiments, wherein the method comprises operating the expansion device based on a superheat control loop for controlling a superheat controlled variable xₛ(t) based on a superheat reference variable wₛ(t) and a superheat feedback variable rₛ(t).

M60. Method according to the preceding method embodiment, wherein operating the expansion device comprises modifying an opening degree of the expansion device based on the superheat reference variable wₛ(t) and the superheat feedback variable rₛ(t).

M61. Method according to any of the 2 preceding method embodiments, wherein operating the expansion device comprises determining a superheat control variable uₛ(t) based on a superheat error signal eₛ(t) corresponding to the difference of the superheat reference variable wₛ(t) and the superheat feedback variable rₛ(t).

M62. Method according to the preceding method embodiment, wherein operating the expansion device further comprises operating the expansion device based on the superheat control variable uₛ(t).

M63. Method according to any of the 2 preceding method embodiments, wherein the superheat control variable uₛ(t) is determined such that the superheat controlled variable x_{c}(t) is stabilized to the superheat reference variable wₛ(t).

M64. Method according to any of the 3 preceding method embodiments, wherein the superheat control variable uₛ(t) of the superheat control loop is indicative of an opening degree of the expansion device.

M65. Method according to any of the 6 preceding method embodiments, wherein the superheat control loop is a closed control loop.

M66. Method according to any of the 7 preceding method embodiments, wherein
the superheat controlled variable xₛ(t) is a superheat SH across the evaporator,
the superheat reference variable wₛ(t) is a target superheat SHₜ, and
the superheat feedback variable rₛ(t) is a current superheat across the evaporator.

M67. Method according to the preceding method embodiment, wherein target superheat SHₜ depends on operational parameters.

M68. Method according to the preceding method embodiment, wherein the operational parameters comprise an ambient temperature of the laboratory device.

M69. Method according to any of the 2 preceding method embodiments, wherein the operational parameters comprise a target sample temperature T_{p,t} for a sample handled by the laboratory device.

M70. Method according to any of the 3 preceding method embodiments, wherein the laboratory device is a centrifuge and wherein the operational parameters comprise a rotor type and/or a rotational frequency of the rotor.

M71. Method according to any of the 4 preceding method embodiments, wherein the method comprise determining a target device temperature T_{d,t} based on the operational parameters and wherein the target superheat depends on the target device temperature.

M72. Method according to any of the 6 method embodiments, wherein the method comprises determining the current superheat as a difference between a suction temperature Tₛ downstream of the evaporator and a low-pressure temperature Tₗ upstream of the evaporator.

M73. Method according to the preceding method embodiment, wherein the method comprises measuring the suction temperature Tₛ with a suction-temperature sensor.

M74. Method according to any of the 2 preceding method embodiments, wherein the method comprises measuring the low-pressure temperature Tₗ with a low-pressure temperature sensor.

M75. Method according to any of M72 or M73, wherein the method comprises measuring a suction pressure downstream of the evaporator with a suction-pressure sensor and calculating the low-pressure temperature based on the suction pressure.

M76. Method according to any of M72 or M73, wherein the method comprises measuring a low pressure pₗ upstream of the evaporator with a low-pressure sensor and calculating the low-pressure temperature based on the low pressure.

M77. Method according to any of the preceding method embodiments and with the features of at least one of M2, M18, M37, M50 or M59, wherein the method comprises determining an initial value for at least one actuator of a control loop.

M78. Method according to the preceding method embodiment, wherein determining an initial value for at least one actuator comprises
receiving operational parameters,
determining, preferably automatically, the initial value for at least one actuator using a characteristic curve map to map at least some of the operational parameters to an initial value for the at least one actuator, and
setting, preferably automatically, the at least one actuator to the respective initial value.

M79. Method according to the preceding method embodiment, wherein the operational parameters comprise an ambient temperature, a target device temperature and/or a target sample temperature.

M80. Method according to any of the 2 preceding method embodiments, wherein the laboratory device is a centrifuge, wherein the operational parameters comprise a rotor type and/or a rotational frequency of the rotor.

M81. Method according to any of the 3 preceding method embodiments, wherein the laboratory device is a vacuum centrifuge and wherein the operational parameters comprise a target vacuum pressure.

M82. Method according to any of the 4 preceding method embodiments, wherein receiving operational parameters comprises a user providing at least one of the operational parameters to the cooling system.

M83. Method according to any of the 5 preceding method embodiments, wherein receiving operational parameters comprises automatically determining at least one operational parameter.

M84. Method according to any of the 7 preceding method embodiments and with the features of M2, wherein the at least one actuator comprises the compressor assembly acting as actuator for the compressor control loop, and wherein the respective initial value comprises at least one compressor frequency.

M85. Method according to the preceding method embodiment, wherein the compressor assembly comprises a first compressor and a second compressor and wherein the initial value comprises an initial common compressor frequency, or an initial designated compressor frequency for each, the first compressor and the second compressor.

M86. Method according to any of the 9 preceding method embodiments and with the features of M18, wherein the at least one actuator comprises the bypass valve acting as actuator for the bypass control loop, and wherein the respective initial value comprises an initial opening degree for the bypass valve.

M87. Method according to any of the 10 preceding method embodiments and with the features of M59, wherein the at least one actuator comprises the expansion device acting as actuator for the superheat control loop, and wherein the respective initial value comprises an initial opening degree for the expansion device.

M88. Method according to any of the 11 preceding method embodiments and with the features of M50, wherein the at least one actuator comprises the high-pressure control valve acting as actuator for the high-pressure control loop, and wherein the respective initial value comprises an initial opening degree for the high-pressure control valve.

M89. Method according to any of the 12 preceding method embodiments and with the features of M43, wherein the at least one actuator comprises the fan acting as actuator for the cooling-device control loop, and wherein the respective initial value comprises an initial fan speed for the fan.

M90. Method according to any of the 13 preceding method embodiments, wherein the characteristic curve map used is actuator dependent.

M91. Method according to any the preceding method embodiments comprising the features of at least one of M15, M17, M25, M29, M33, M34, M36, M71, or M79 wherein the method further comprises determining, preferably automatically, the target device temperature T_{t,d} based on operational parameters.

M92. Method according to the preceding method embodiment, wherein the operational parameters comprise an ambient temperature and/or a target sample temperature.

M93. Method according to any of the 2 preceding method embodiments, wherein the laboratory device is a centrifuge, wherein the operational parameters comprise a rotor type and/or a rotational frequency of the rotor.

M94. Method according to any of the 3 preceding method embodiments, wherein the laboratory device is a vacuum centrifuge and wherein the operational parameters comprise a target vacuum pressure.

M95. Method according to any of the 4 preceding method embodiments, wherein the method comprises receiving operational parameters.

M96. Method according to the preceding method embodiment, wherein receiving operational parameters comprises a user providing at least one of the operational parameters to the cooling system.

M97. Method according to any of the 2 preceding method embodiments, wherein receiving operational parameters comprises automatically determining at least one operational parameter.

M98. Method according to any of the 7 preceding method embodiments, wherein determining the target device temperature T_{t,d} comprises determining an amount of heat generated by the laboratory device during operation based on the operational parameters.

M99. Method according to the preceding method embodiment, wherein determining the target device temperature T_{t,d} comprises translating a target sample temperature into a target device temperature based on the amount of heat and optionally the ambient temperature.

M100. Method according to any of the 9 preceding method embodiments, wherein determining of the target device temperature is implemented using a characteristic curve map.

M101. Method according to any of the 10 preceding method embodiments and with the features of M79, wherein the step of determining the initial value for at least one actuator comprises the step of determining the target device temperature T_{t,d}.

M102. Method according to any of the preceding embodiments comprising the features of M50 and M59, wherein the method comprises operating the high-pressure control valve and the expansion device independently from each other.

M103. Method according to any of the preceding embodiments comprising the features of M50 and M59, wherein the high-pressure control loop and the superheat control loop are independent of each other.

M104. Method according to any of the preceding method embodiments, wherein the system comprises the features of S42 and wherein the method comprises shutting down the compressor assembly if an intermediate pressure in the intermediate pressure section rises above an intermediate pressure threshold.

M105. Method according to the preceding method embodiment, wherein the shutting down is initiated by an intermediate-pressure switch located in the intermediate-pressure section.

M106. Method according to any of the 2 preceding method embodiments, wherein the intermediate-pressure threshold is in the range of 80 to 95 bar, preferably in the range of 85 to 90 bar, such as 88 bar.

M107. Method according to any of the preceding method embodiments, wherein the method comprises shutting down the compressor assembly if the pressure downstream of the compressor assembly rises above a high-pressure threshold.

M108. Method according to any of the preceding method embodiments, wherein the system comprises the features of S40 and wherein the method comprises shutting down the compressor assembly if the pressure in the high-pressure section rises above a high-pressure threshold.

M109. Method according to the preceding method embodiment, wherein the shutting down is initiated by a high-pressure switch located in the high-pressure section.

M110. Method according to any of the 3 preceding method embodiments, wherein the shutting down is initiated by a high-pressure switch located downstream of the compressor assembly and upstream of the cooling device.

M111. Method according to any of the 4 preceding method embodiments, wherein the high-pressure threshold is in the range of 110 to 140 bar, preferably in the range of 120 to 130 bar.

M112. Method according to any of the preceding method embodiments, wherein the method comprises shutting down the compressor assembly if a temperature downstream of the compressor assembly and upstream of the cooling device rises above a temperature threshold.

M113. Method according to the preceding method embodiment, wherein the shutting down is initiated by a temperature switch located downstream of the compressor assembly and upstream of the cooling device.

M114. Method according to any of the 2 preceding method embodiments, wherein the temperature threshold is in the range of 110 to 130° C., preferably in the range of 115 to 125° C., such as 120° C.

M115. Method according to any of the preceding method embodiments, wherein the method comprises shutting down a drive of the laboratory device in case a device-temperature rises above a device-temperature threshold.

M116. Method according to any of the preceding method embodiments, wherein the method comprises monitoring the device-temperature with a device-temperature sensor and shutting down a drive of the laboratory device in case a device temperature rises above a drive-temperature threshold.

M117. Method according to any of the 2 preceding method embodiments, wherein the device-temperature threshold is in the range of 40° C. to 100° C., preferably in the range of 50° C. to 80° C., more preferably in the range of 50° C. to 70° C., such as 60° C.

S69. The cooling system according to any of the preceding system embodiments, wherein the system is configured to perform the method according to any of the preceding method embodiments.

S70. The cooling system according to any of the preceding system embodiments and with the features of S53, wherein the controller is configured to perform the method according to any of the preceding method embodiments.

S71. The cooling system according to the preceding system embodiment, wherein the method comprises the features of M2 and wherein the controller also serves as controller for the compressor control loop.

S72. The cooling system according to any of the 2 the preceding system embodiments, wherein the method comprises the features of M18 and wherein the controller also serves as controller for the bypass control loop.

S73. The cooling system according to any of the 3 the preceding system embodiments, wherein the method comprises the features of M37 and wherein the controller also serves as controller for the cooling-device control loop.

S74. The cooling system according to any of the 4 the preceding system embodiments, wherein the method comprises the features of M50 and wherein the controller also serves as controller for the high-pressure control loop.

S75. The cooling system according to any of the 5 the preceding system embodiments, wherein the method comprises the features of M59 and wherein the controller also serves as controller for the superheat control loop.

### BRIEF DESCRIPTION OF THE DRAWINGS

Embodiments of the present invention will now be described with reference to the accompanying drawings. These embodiments should only exemplify, but not limit, the present invention.

FIG. 1 depicts an exemplary embodiment of a cooling system;

FIG. 2 depicts another exemplary embodiment of a cooling system;

FIGS. 3 to 8 depict embodiments of closed control loops; and

FIG. 9 depicts a method according to the present invention.

It is noted that not all the drawings carry all the reference signs. Instead, in some of the drawings, some of the reference signs have been omitted for the sake of brevity and simplicity of the illustration. Embodiments of the present invention will now be described with reference to the accompanying drawings.

### DETAILED DESCRIPTION

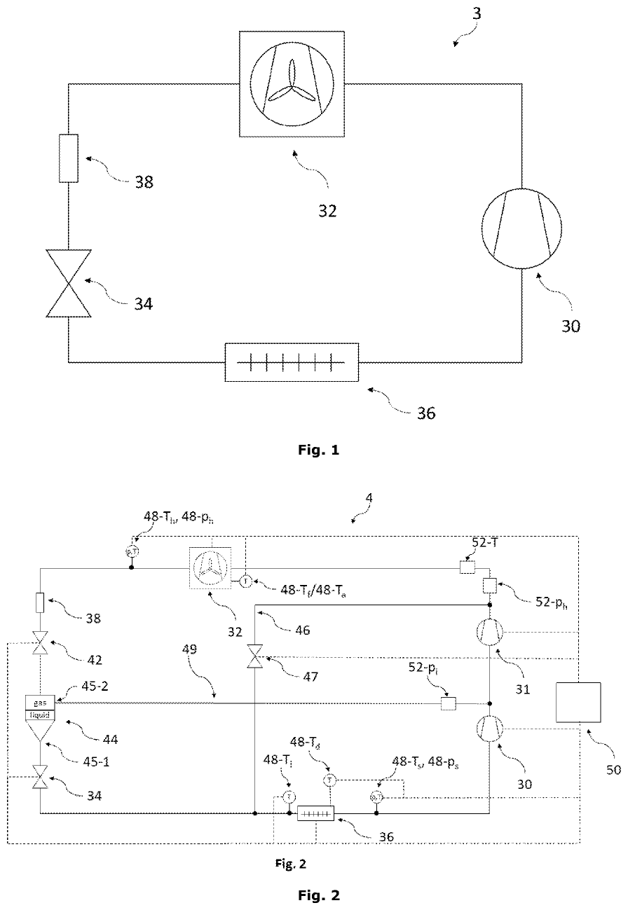

With reference to FIG. 1 a basic cooling system 3 of a laboratory device is shown. The cooling system 3 comprises a compressor assembly comprising a single compressor 30, a cooling device 32, an expansion device 34, e.g. an expansion valve 34, and an evaporator 36. These components may be fluidly connected via respective tubes and arranged in a cycle, which may also be referred to as a main cycle. In particular, a refrigerant, preferably CO₂, may be circulated to provide for heat dissipation at the evaporator 36. Thereby, cooling of a laboratory device or an element thereof thermally connected to the evaporator may be enabled. In particular, the evaporator 36 may be part of a laboratory device, e.g. a centrifuge, and may be configured to cooling at least a portion of said laboratory device, e.g. a rotor chamber of the centrifuge.

The expansion device 34 may be an expansion valve. Preferably, the expansion valve may be a control valve, such as an electric stepper motor valve (or simply electric stepper valve), wherein an opening degree of the expansion valve may be set by means of an electric stepper motor.

The compressor 30 may compress the refrigerant, such that it is provided at a higher pressure at an outlet of the compressor 30 (compared to an inlet of the compressor) from where it may be guided to the cooling device 32, which may comprise (or be) a gas cooler, e.g. a gas cooler with a fan providing a stream of air at ambient temperature across a cooling body of the gas cooler 32. The cooling device may essentially reduce the temperature of the refrigerant. In other words, it may reduce heat that the refrigerant gained at the compressor 30 and thus reduce the enthalpy of the refrigerant. Depending on the cooling system and the refrigerant used, this may allow the refrigerant to change from a gaseous phase into a liquid phase. Therefore, the cooling device may also comprise (or be) a condenser. Subsequently, the refrigerant may be guided to the expansion device 34, wherein the pressure of the refrigerant may be reduced. This may allow a liquid refrigerant to transition from a liquid phase to a wet vapour phase. Finally, the refrigerant may be guided to the evaporator 36 for taking up heat and thereby increasing the enthalpy of the refrigerant. To close the cycle, the refrigerant is then guided back to the compressor 30, which may again compress the refrigerant and restart the cycle.

Additionally, the cooling system 3 may comprise a filter dryer 38, which may be located downstream of the cooling device 32 and upstream of the expansion device 34. The filter dryer 38 may be configured to filter contaminants and remove moisture from the refrigerant.

In this document, the terms “upstream” and “downstream” are used at various points. For example, with regard to FIG. 1, it should be clear that the refrigerant flows in an anti-clockwise direction, so that the expansion device 34 is located downstream of the filter dryer 38, for example.

At the same time, it should be noted that the process used is a cyclic process. After the refrigerant has left the expansion device 34, it will pass through the evaporator 36, the compressors 30 and the cooler 32 and will then return to the filter dryer 38 after a certain time.

However, it should be understandable that the fluid connection between the filter drier 38 and the expansion device 34 is shorter than the connection from the expansion device 34 (via the other elements) to the filter drier 38. In this document, the terms “upstream” and “downstream” therefore refer to the shorter fluid connection between two elements. Thus, for example, as discussed, the expansion device 34 is located downstream of the filter dryer 38 and the evaporator 36 is located downstream of the expansion device 34. Another example is the compressor 30, which is located downstream of the evaporator 36 and upstream of the cooling device 32.

Again, FIG. 1 depicts merely a basic cooling system 3, which may be altered and/or tailored to increase the systems efficiency and/or adapted to particularly work with CO₂ as refrigerant. In particular, additional heat and/or refrigerant flows may be established to optimize operation of the cooling system. Additionally, or alternatively a two-staged compressor system may be realized, wherein the refrigerant may be compressed in two stages, which may for example allow intermitted cooling and generally reduce the load on the compressor compared to using a single staged process. Further variants and details on such a cooling system are for example disclosed in DE 10 2021 125 446 A1 which is herby incorporated by reference.

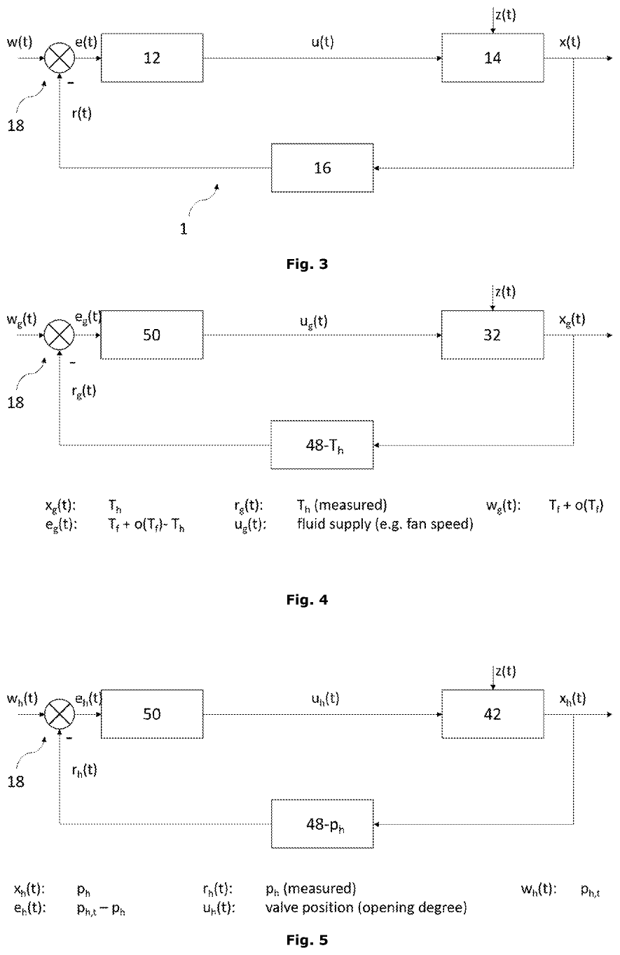

A more elaborate and improved cooling system 4 is depicted in FIG. 2. This system is based on a two-staged compression cycle, wherein the cooling fluid is compressed in two stages. In particular, the system 4 may comprise a compressor assembly comprising a first compressor 30 and a second compressor 31. It will be understood that the first compressor 30 and the second compressor 31 can be arranged in a housing, in particular, a common housing. A common drive may be provided for the first compressor 30 and the second compressor 31, which is configured to drive both the first compressor 30 and the second compressor 31. Thus, a first compression may be provided by the first compressor 30 and a second compression may be provided by the second compressor 31 to bring the refrigerant from a low pressure at an outlet of the evaporator 36 to a high pressure at an outlet of the second compressor 31.

Furthermore, the system 4 may comprise an intermediate-pressure accumulator 44 (also referred to as middle-pressure accumulator 44) and a high-pressure control device 42, e.g. a high-pressure control valve 42. The high-pressure control device 42 may in some cases be a capillary tube configured with a fixed cross section such that a predetermined flow of refrigerant may be provided under typical conditions (e.g. typical ambient temperature and/or applications). While this may advantageously allow to reduce the elements that may need to be controlled during operation of the cooling system it may in turn increase the demand on the control of the remaining elements, which may for example need a higher dynamic range to account for the lack of control of the high-pressure control device. Preferably, the high-pressure control device 42 may thus be a high-pressure control valve, such as an electric stepper motor valve (or simply electric stepper valve), wherein an opening degree of the high-pressure control valve may be set by means of an electric stepper motor.

The intermediate-pressure accumulator may be located upstream of the expansion device 34 and downstream of the high-pressure control device 42, which may be located downstream of the filter dryer 38. Thus, the high-pressure control device 42 and the intermediate-pressure accumulator 44 may both be located in the main cycle of the system and between the filter dryer 38 and the expansion device 34. The high-pressure control device 42 may be configured to reduce the high pressure of the refrigerant downstream of the cooling device 32 to an intermediate (middle) pressure. In particular, a transition of the cooling fluid from a fluid phase or transcritical phase to the wet vapor phase can be realized here. At a first outlet 45-1 of the intermediate-pressure accumulator 44, liquid refrigerant may be provided and guided to the expansion device 34 as part of the main cycle. Thus, the expansion device 34 may also be referred to as low-pressure control device 34 in such a cooling system 4.

Additionally, a return section 49 may fluidly connect a second outlet 45-2 of the intermediate-pressure accumulator 44 to the main cycle between the first compressor 30 and the second compressor 31. That is, the return section 49 may be fluidly connected to the main cycle downstream of the first compressor 30 and upstream of the second compressor 31. This may allow to alter the enthalpy of the refrigerant going into the second compressor. In particular, it may allow to control the temperature of the refrigerant at the output of the second compressor 31. Thus, at least partially gaseous refrigerant or refrigerant in the wet vapor phase can be introduced into the return section 49 via the second outlet 45-2 of the intermediate-pressure accumulator 44. The second compressor 31 may suck the refrigerant out of the intermediate-pressure accumulator 44 via the return section 49. As an alternative to providing the refrigerant at an intermediate pressure between the first and second compressor, the refrigerant can also be mixed with low-pressure refrigerant in the gas phase, e.g. the return section 49 can also be fluidly connected to the main cycle upstream of the first compressor 30.

Yet further, the cooling system 4 may comprise a hot-gas bypass 46 comprising a bypass valve 47. The hot-gas bypass 46 may be fluidly connected to the main cycle at a connection point downstream of the second compressor 31 and upstream of the cooling device 32, and at a connection point downstream of the expansion device 34 and upstream of the evaporator 36. Thus, the hot-gas bypass 46 may allow to add hot refrigerant provided at the outlet of the second compressor 31 to the expanded refrigerant right before the evaporator 36. This may allow to better control the temperature at the evaporator and can even allow to heat a laboratory device thermally coupled to the evaporator. The bypass valve may preferably be a control valve, such as an electric stepper motor valve (or simply electric stepper valve), wherein an opening degree of the bypass valve may be set by means of an electric stepper motor.

Thus, it will be understood that the system 4 may generally be considered to comprise a high-pressure section, which may generally be between the output of the second compressor 31, the inlet of the bypass valve 47 and the inlet of the high-pressure control device 42, an intermediate-pressure section, which may generally be between the outlet of the high-pressure control device 42, the input of the expansion device 34, the outlet of the first compressor 30 and the inlet of the second compressor, and a low pressure section, which may generally be between an outlet of the expansion device 34, an input of the first compressor 30 and an outlet of the bypass valve 47.

Additionally, the cooling system 4 may comprise a plurality of temperature and/or pressure sensors 48 at different locations throughout the system. For example, a suction-temperature sensor 48-Tₛ and/or a suction-pressure sensor 48-pₛ may be located downstream of the evaporator 36 and upstream of the compressor assembly, i.e. upstream of the first compressor 30, to measure temperature and/or pressure of the refrigerant after passing through the evaporator 36. These sensors 48-Tₛ, 48-pₛ may be provided as individual sensors or as a combined temperature-pressure sensor. A fluid-temperature sensor 48-T_{f} may be provided at or within the cooling device 32, e.g. for measuring the temperature of a fluid for transporting heat from the refrigerant or respectively the cooling device 32, e.g. ambient air. Thus, the fluid-temperature sensor 48-T_{f} may also be referred to as ambient-temperature sensor 48-Tₐ if the fluid for transporting heat from the refrigerant/cooling device is ambient air, which may be preferred. Alternatively, the system may comprise a dedicated ambient-temperature sensor 48-Tₐ. A high-pressure sensor 48-pₕ and/or a high-pressure temperature sensor 48-Tₕ may be located downstream of the cooling device 32 and upstream of the high-pressure control device 42, e.g. upstream or downstream of the filter drier 38, which may be configured to measure temperature and/or pressure of the refrigerant downstream of the cooling device. A low-pressure temperature sensor 48-Tₗ may be located downstream of the expansion device 34 and upstream of the evaporator 36. Furthermore, it may also be located downstream of a point of connection of the hot-gas bypass 46. Thus, the low-pressure temperature sensor 48-Tₗ may be configured to measure the temperature of the refrigerant after passing the expansion device 34 and prior to the evaporator 36, preferably downstream of any mixing with refrigerant of the hot-gas bypass 46. Alternatively, the low-pressure temperature Tₗ may be calculated, e.g. based on the suction pressure pₛ. A device-temperature sensor 48-T_{d} may be located at or within the evaporator, e.g. to determine a temperature within the evaporator and/or a device thermally coupled to, or comprising the evaporator 36. It will be understood that the system may comprise additional sensors and that the afore mentioned are merely exemplary.

In some embodiments the cooling system may additionally comprise at least one safety switch 52. In particular, the cooling system 4 may comprise an intermediate-pressure switch 52-pᵢ, which may initiate shutdown of the compressor assembly (i.e. the compressor(s)) in case the intermediate pressure in the intermediate pressure section rises above an intermediate pressure threshold. The intermediate-pressure threshold may for example lie in the range of 80 to 95 bar, preferably in the range of 85 to 90 bar, such as 88 bar. In other words, the intermediate pressure switch 52-pᵢ may monitor the pressure in the intermediate-pressure section, e.g. in the return section 49 and upon registering a pressure above the intermediate-pressure threshold initiate shutdown of the compressor assembly, e.g. by cutting the power provided for running the compressor assembly.

Such an intermediate-pressure switch 52-pᵢ can advantageously be designed to fulfil less demanding specifications in comparison to a switch in the high-pressure section, since it is only required to handle intermediate pressures present in the intermediate-pressure section. Thus, they can be classified lower according to the pressure equipment directive, which may lead to the entire device being classified lower. This may advantageously reduce “end-of-line” testing efforts.

A cascade of error events may for example start with a failure of the cooling device, e.g. a blockage or failure of the fan of an air-cooled gas cooler. This may in turn lead to overheating and an increase in pressure in the section downstream of the cooling device 32. This may trigger the opening of the high-pressure control valve 42, which may in turn lead to an increase in pressure in the intermediate-pressure section, causing the intermediate-pressure switch 52-pᵢ to activate and shut down the compressor(s). Thus, a further build-up of pressure and/or temperature may advantageously be prevented.

The cooling system 4 may comprise a high-pressure switch 52-pₕ, which may activate when the pressure in the high-pressure section upstream of the compressor assembly surpasses a high-pressure threshold (or maximum pressure) and initiate shutdown of the compressor assembly, e.g. by cutting the power provided for running the compressor assembly. The high-pressure threshold may be in the range of 110 to 140 bar, preferably in the range of 120 to 130 bar. The high-pressure switch 52-pₕ may for example activate due to the high-pressure control valve 42 not functioning (e.g. not regulating) correctly.

The cooling system 4 may also comprise a temperature switch 52-T. The temperature switch 52-T may be configured to shut down the compressor assembly when a temperature threshold (or maximum temperature) is exceeded. This temperature threshold may be in the range of 110 to 130° C., preferably in the range of 115 to 125° C., such as 120° C. Shutting down the compressor(s) for temperatures above the temperature threshold may advantageously prevent a short circuit in the compressor windings and/or coking of the oil in the compressor.

As an additional safety measure a drive of the laboratory device (or the whole laboratory device) may be shut down by a controller 50 in case the device temperature T_{d} measured at device-temperature sensor 48-T_{d} exceeds a device-temperature threshold. The device temperature threshold may for example be in the range of 40° C. to 100° C., preferably in the range of 50° C. to 80° C., more preferably in the range of 50° C. to 70° C., such as 60° C. In particular, if the laboratory device is a centrifuge, the device temperature T_{d} may denote the temperature in the centrifuge chamber and the centrifuge drive may be shut down by the controller when the device temperature surpasses the device-temperature threshold.

The system 4 may generally comprise at least one controller 50, which may be operatively connected to system components as for example indicated by the dashed lines in FIG. 2. In particular, the controller may be operatively connected to sensors comprised by the system, to the expansion device 34, the high-pressure control valve 42, the bypass valve 47, the cooling device 32, the compressors 30, 31 and/or the evaporator 36. This may allow to control operation of the system and/or parts (e.g. subsections of it). In particular, one or more control loops may be implemented in the system, wherein the controller 50 may preferably serve as controller for all of the implemented control loops.

The controller may include a data processing unit and may be configured to control the system and carry out particular method steps. The controller can send or receive electronic signals for instructions. The controller can also be referred to as a microprocessor. The controller can be contained on an integrated-circuit chip. The controller can include a processor with memory and associated circuits. A microprocessor is a computer processor that incorporates the functions of a central processing unit on a single integrated circuit (IC), or sometimes up to a plurality of integrated circuits, such as 8 integrated circuits. The microprocessor may be a multipurpose, clock driven, register based, digital integrated circuit that accepts binary data as input, processes it according to instructions stored in its memory and provides results (also in binary form) as output. Microprocessors may contain both combinational logic and sequential digital logic. Microprocessors operate on numbers and symbols represented in the binary number system

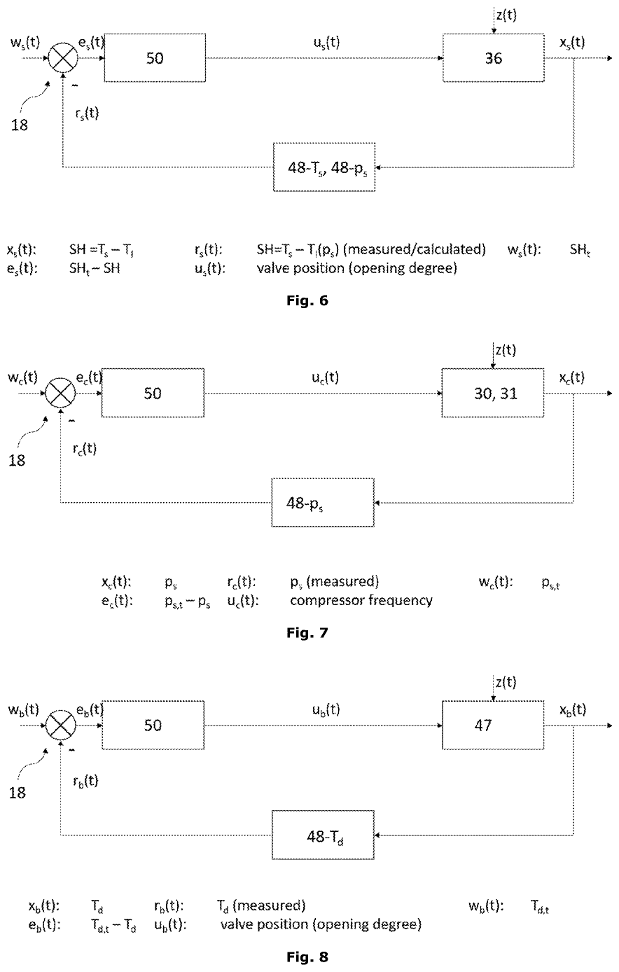

A control loop may generally be configured to control a variable in a system, which may be referred to as controlled variable x(t) or manipulated variable x(t). Very generally a control loop may comprise a controller 12, and a controlled system 14 (which may also be referred to as plant). Two categories of control loops are generally known: open-loop control systems (feedforward) and closed-loop control systems (feedback). The main difference being that open-loop control systems manipulate the controlled variable based on an input and without any feedback as to how the controlled variable is affected. The present invention will only make use of closed-loop control systems as depicted in FIG. 3.

In a closed loop control system, a reference variable w(t) also referred to as setpoint w(t) may be provided, which may generally represent a target value for the controlled variable x(t). Additionally, a closed-loop control system 1 may be configured to provide a feedback variable r(t), in particular it may comprise at least one sensor 16 configured to provide a measurement for determining the feedback variable r(t), which may be indicative (or preferably correspond to) a current value of the controlled variable x(t). The feedback variable r(t) may also be referred to as measured output. Furthermore, the system may comprise a comparator 18 configured to determine an error e(t) based on the feedback variable r(t) and the reference variable w(t). The error e(t) (also referred to as error signal, system deviation, or measured error) may correspond to a difference between the reference variable w(t) and the feedback variable r(t): e(t)=w(t)−r(t). Said error e(t) may then be provided as an input to the controller 12, which may provide a control variable u(t) (also referred to as controller output variable u(t) or system input u(t)). Based on this control variable u(t) the controlled system 14 may be manipulated, such that the controlled variable x(t) is altered. In particular an actuator comprised by the controlled system may be operated/manipulated based on the control variable u(t), to affect a change in the controlled variable. That is, the actuator is controlled by the controller via the control variable u(t) to alter the controlled variable x(t) based on the reference variable w(t) and the feedback variable r(t) Thus, by providing the feedback variable r(t) a closed-loop control system may allow to take into account the actual value of the controlled variable x(t), and may thus also consider any disturbances z(t) to the controlled system 14.

Thus, the controlled system 14 and particularly an actuator thereof may be operated based on the control loop, which is configured for controlling the controlled variable x(t) based on the reference variable w(t) and the feedback variable r(t). In particular, the control variable u(t) may be determined based on an error signal e(t) corresponding to the difference of the reference variable and the feedback variable: e_{c}(t)=w_{c}(t)−r_{c}(t). Subsequently the system 14 and particularly the respective actuator comprised by the system 14 may be operated based on the control variable u(t) to affect the controlled variable x(t) in a desired way, preferably to stabilize the controlled variable x(t) to the reference variable w(t).

The present invention may relate to a plurality of control loops for a cooling system.

With reference to FIG. 4, a cooling-device control loop may be provided for controlling the high-pressure temperature Tₕ of the refrigerant downstream of the cooling device 32. That is, a cooling-device controlled variable x_{g}(t) of the cooling-device control loop may be the high-pressure temperature Tₕ of the refrigerant downstream of the cooling device 32 and upstream of the high-pressure control device 42, which may be measured with the temperature sensor 48-Tₕ. A cooling-device control variable u_{g}(t) may be indicative of a desired fluid supply to the cooling device for transporting heat away from the refrigerant/cooling device, thereby cooling the refrigerant running through the main cycle. A cooling-device reference variable w_{g}(t) may provide a target refrigerant temperature downstream of the cooling device and upstream of the high-pressure control device, i.e. a target high-pressure temperature of the refrigerant T_{h,t}. The cooling-device control loop may be implemented as closed-loop control system, wherein a cooling-device feedback variable r_{g}(t) may be provided by the temperature sensor 48-Tₕ measuring the current refrigerant temperature Tₕ downstream of the cooling device 32. This may advantageously allow for a more stable control of the refrigerant temperature since the actual refrigerant temperature is fed back as the feedback variable, thus unknown disturbances z(t) to the system can be better accounted for.

The target high-pressure temperature T_{h,t}, i.e. the cooling-device reference variable w_{g}(t), may be chosen depending on the temperature of the fluid supplied to the cooling device, i.e., the fluid temperature T_{f}. Generally, the fluid temperature T_{f} may define a lower limit to for the high-pressure temperature Tₕ. In particular, the cooling-device reference variable w_{g}(t) may correspond to or depend on the temperature of the fluid supplied to the cooling device (w_{g}(t)=T_{f}). Alternatively, the cooling-device reference variable w_{g}(t) may be set to a value independent of the fluid temperature, e.g. a pre-set value w₀ corresponding to a typical desired high-pressure temperature of the refrigerant. Alternatively, an offset o(T_{f}) may be added to the pre-set value w₀ or the fluid temperature T_{f}, such that w_{g}(t)=w₀+o(T_{f}) or respectively w_{g}(t)=T_{f}+o(T_{f}), wherein the offset itself depends on the fluid temperature T_{f}. This may advantageously allow to adapt the cooling capacity to the cooling demand, which depends on the ambient temperature. It will be understood that instead altering the cooling-device reference variable w_{g}(t) based on the fluid temperature, the cooling-device feedback variable r_{g}(t) may be modified, e.g. the offset may be subtracted from the current (measured) high-pressure temperature to provide the cooling-device feedback variable r_{g}(t).

Preferably, the cooling device may comprise a fan for supplying ambient air as fluid for transporting heat, i.e. as cooling fluid for the cooling device 32. Thus, the cooling-device control variable u_{g}(t) may preferably relate to the fan speed (i.e., a signal indicative of the fan speed), and the fan itself may constitute the actuator within the cooling-device control loop. In such a case the fluid temperature T_{f} would be the ambient temperature T_{a.} In other words, the cooling-device controlled variable x_{g}(t) may be the refrigerant temperature Tₕ measured downstream of the cooling device 32 (e.g. gas cooler) and upstream of the high-pressure control valve 42, which is may be used to control the fan speed of a fan that is comprised by the cooling device 32 to provide ambient air, and to remove heat from the cooling device 32. I.e. the fan comprised by the cooling device (e.g. gas cooler) may serve as the actuator of the cooling-device control loop. Again, the cooling-device reference variable w_{g}(t) may be chosen depending on the temperature of the fluid supplied to the cooling device (e.g., ambient air temperature). In other words, the temperature of the fluid (e.g., ambient air), may be considered, for example to deduct an offset.

Thus, cooling device may be operated based on the cooling-device control loop, which is configured for controlling the cooling-device controlled variable x_{g}(t) based on the cooling-device reference variable w_{g}(t) and the cooling-device feedback variable r_{g}(t). Operating the cooling-device may particularly comprise modifying the cooling power of the cooling-device. In particular, the cooling-device control variable u_{g}(t) may be determined based on a cooling-device error signal e_{g}(t) corresponding to the difference of the cooling-device reference variable and the cooling-device feedback variable: e_{g}(t)=w_{g}(t)−r_{g}(t). Subsequently, the cooling-device may be operated based on the cooling-device control variable u_{g}(t) to affect the cooling-device controlled variable x_{g}(t), e.g. the fan providing ambient air may run with the respective rotational frequency determined by the controller. This may allow to stabilize the cooling-device controlled variable x_{g}(t) to the cooling-device reference variable w_{g}(t).

The cooling-device control loop may advantageously allow to modify the cooling power of the cooling device, e.g. by modifying the fan speed, based on the current refrigerant temperature. This may allow to keep the high-pressure section more stable at a desired pressure by removing excessive heat. Additionally, the noise of the cooling device, e.g. a fan thereof, may advantageously be reduced (at least on average) as the cooling power is adjusted based on a current need, e.g. the fan speed may be controlled in a wide range.

With reference to FIG. 5, a high-pressure control loop may be provided for controlling the pressure upstream of the high-pressure control valve 42. In particular, a high-pressure controlled variable xₕ(t) of the high-pressure control loop may be the pressure of the refrigerant upstream of the high-pressure control valve 42 and downstream of the cooling device 32, i.e. the high pressure pₕ which may be measured with the pressure sensor 48-pₕ. A high-pressure control variable uₕ(t) may be indicative of a desired valve position or put differently a desired opening degree of the high-pressure control valve 42. The high-pressure control loop may be implemented as closed-loop control system, wherein a high-pressure reference variable wₕ(t) provides a target high pressure of the refrigerant p_{h,t} and a high-pressure feedback variable rₕ(t) is provided by the pressure sensor 48-pₕ. The high-pressure reference variable wₕ(t) may in some embodiments depend on the refrigerant temperature Tₕ upstream of the high-pressure control valve 42 and downstream of the cooling device 32, which may be measured with the temperature sensor 48-Tₕ. In particular, the target pressure p_{h,t} may preferably be determined based on the high-pressure temperature Tₕ, i.e. p_{h,t}(Tₕ). Said relation may for example be defined through a polynomial function. Thus, the target pressure p_{h,t} may be calculated based on the current high pressure temperature Tₕ preferably measured with a respective temperature sensor 48-Tₕ, p_{h.} The target pressure p_{h,t}(Tₕ) may be continuously updated based on the current high pressure temperature Tₕ. In general, a combined sensor 48-Tₕ, pₕ may be provided, configured to measure both, pressure and temperature of the refrigerant.

Thus, the high-pressure control valve 42 may be operated based on the high-pressure control loop, which is configured for controlling the high-pressure controlled variable xₕ(t) based on the high-pressure reference variable wₕ(t) and the high-pressure feedback variable rₕ(t). Operating the high-pressure control valve may particularly comprise modifying an opening degree of the high-pressure control valve. In particular, the high-pressure control variable uₕ(t) may be determined based on a high-pressure error signal eₕ(t) corresponding to the difference of the high-pressure reference variable and the high-pressure feedback variable: eₕ(t)=wₕ(t)−rₕ(t). Subsequently, the high-pressure control valve may be operated based on the high-pressure control variable uₕ(t) to affect the high-pressure controlled variable xₕ(t) e.g. the opening degree of the high-pressure control valve may be set to a value determined by the controller. This may allow to stabilize the high-pressure controlled variable x_{g}(t) to the high-pressure reference variable w_{g}(t).

In other words, the high-pressure controlled variable xₕ(t) of the high-pressure control loop may be the pressure pₕ measured downstream of the cooling device 32 and upstream of the high-pressure control valve 42, which may be used to control the opening degree of the high-pressure control valve 42. I.e. the high-pressure control valve 42 may function as an actuator for the high-pressure control loop. In a modification, the high-pressure reference variable wₕ(t) (also high-pressure target variable wₕ(t)) for the pressure may be determined as a function of the temperature of the refrigerant measured downstream of the cooling device 32.

The high-pressure control loop may allow to modify the high-pressure control valve (e.g. an electric stepper valve) to achieve a target pressure in the high-pressure section based on the measurement of a pressure sensor and optionally the refrigerant temperature and/or ambient temperature. For example, limiting the high pressure in high ambient temperature may allow for the cooling system to still run in high ambient temperatures up to 40° C. without system failures. Generally, the high-pressure section may be needed to remove access heat resulting from cooling at the evaporator.

With reference to FIG. 6, a superheat control loop may be provided for controlling the refrigerant temperature at the evaporator and particularly for controlling a temperature difference of the refrigerant between an inlet and an outlet of the evaporator 36. In particular, a superheat controlled variable xₛ(t) of the superheat control loop may be the so-called “superheat” (SH), which denotes the difference between the suction temperature Tₛ downstream of the evaporator 36 and the low-pressure temperature Tₗ upstream of the evaporator 36. The refrigerant temperature Tₛ (also referred to as suction temperature Tₛ) downstream of the evaporator 36 may be measured upstream of the compressor assembly, i.e. upstream of the first compressor 30, and may be measured with sensor 48-Tₛ, which may be a combined temperature and pressure sensor 48-Tₛ, pₛ. The refrigerant temperature upstream of the evaporator 36 may be measured downstream of the expansion device 34 and may be measured with temperature sensor 48-Tₗ. Alternatively and preferably, the low-pressure temperature may be calculated based on the suction pressure pₛ downstream of the evaporator, which may be measured with sensor 48-pₛ, or based on a low pressure pₗ of the refrigerant measured at the inlet of the evaporator. Thus, a superheat feedback variable rₛ(t) may be a current superheat that may be determined as the difference in refrigerant temperature across the evaporator, which temperatures may be measured temperatures and/or determined based on measured pressures. A superheat control variable uₛ(t) may be indicative of a valve position or put differently on a desired opening degree of the expansion device 34. The superheat control loop may be implemented as closed-loop control system, wherein a superheat reference variable wₛ(t) may provide a target superheat SHₜ, i.e. temperature difference of the refrigerant, across the evaporator 36. The target superheat SHₜ, i.e. the superheat reference variable wₛ(t), may depend on operational parameters. Such an operational parameter may for example be a target value for a device temperature T_{d,t} within the laboratory device comprising the evaporator 36 and/or being thermally coupled to the evaporator 36. Similarly, also the ambient temperature Tₐ of the laboratory device may be comprised by the operational parameters.

For example, in case of the laboratory device being a centrifuge, the device temperature T_{d} may be a temperature measured within the centrifuge vessel. In such a case, other operational parameters may for example be a rotor type, and/or a rotor speed/rotational frequency of the rotor. The rotor type may for example be identified using a rotor identification. In particular, the target value for the device temperature T_{d,t} may be determined based on the ambient temperature, the rotor type, the rotor speed (rotational frequency of the rotor) and/or a target sample temperature T_{p,t}. The rotor type may define a drag coefficient describing the friction of the rotor, and the drag coefficient and rotor speed may in combination determine an amount of heat generated by the friction of the rotor. The amount of heat generated by friction within a certain time interval for a particular rotor (rotor power) may define how a temperature in the centrifuge chamber may translate into a sample temperature Tₚ (temperature of the sample to be centrifuged). The sample temperature may be important form an application perspective and a target sample temperature T_{p,t} may advantageously be provided by the user using a user interface. Alternatively, the target sample temperature may be defined for a particular workflow for processing a sample to be centrifuged.

Thus, the expansion device may be operated based on the superheat control loop, which is configured for controlling the superheat controlled variable xₛ(t) based on the superheat reference variable wₛ(t) and the superheat feedback variable rₛ(t). Operating the expansion device may particularly comprise modifying the opening degree of the expansion device. In particular, the superheat control variable uₛ(t) may be determined based on a superheat error signal eₛ(t) corresponding to the difference of the superheat reference variable and the superheat feedback variable: eₛ(t)=wₛ(t)−rₛ(t). Subsequently, the expansion device may be operated based on the superheat control variable uₛ(t) to affect the superheat controlled variable xₛ(t), e.g. the opening degree of the expansion device may be set to a value determined by the controller. This may allow to stabilize the superheat controlled variable xₛ(t) to the superheat reference variable wₛ(t).

Controlling the superheat may allow to ensure efficiency of the cooling process. Particularly, it may allow to provide a flow of refrigerant that allows for sufficient supply of refrigerant for dealing with a heat load at the evaporator while preventing too high supply of refrigerant, which may otherwise disadvantageously lead to liquid refrigerant at the inlet of the first compressor 30.

In other words, the superheat controlled variable may be the temperature Tₛ measured at the outlet of the evaporator and the low-pressure temperature Tₗ at the inlet of the evaporator, in particular the difference between these, which may be referred to as “superheat” SH. Said temperature difference may be used as superheat controlled variable xₛ(t) to control the opening degree of the expansion device 34. The temperature upstream of the evaporator may be measured at the inlet of the evaporator 36, calculated from a pressure measured at the evaporator inlet, calculated based on the pressure measured at the outlet of the evaporator. The temperature Tₛ and the pressure pₛ downstream of the evaporator (e.g., at the outlet of the evaporator) can be measured with different sensors, or alternatively, the sensor for measuring the pressure and the sensor for measuring the temperature can be integrated into a combined sensor. Advantageously, the target value wₛ(t) for the superheat may depend on device parameters, such as the target value for the device temperature, the ambient temperature, and in case of a centrifuge rotor type and rotor speed.

Generally, the superheat control loop in combination may allow advantageously allow to improve the cooling (and optionally heating) efficiency of the cooling system through modification of the reference variable wₓ(t) of the superheat control loop, e.g. the target superheat. This may particularly improve efficiency compared to a manually operated mechanical expansion valve.

With reference to FIG. 7, a compressor control loop may be provided for controlling the pressure in the low-pressure section, i.e. downstream of the expansion device 34 and upstream of the compressor assembly, thus particularly upstream of the first compressor 30. That is, a compressor controlled variable x_{c}(t) of the compressor control loop may be the pressure of the refrigerant in the low-pressure section of the cooling cycle and thus a compressor feedback variable r_{c}(t) may be the current (measured) pressure of the refrigerant in the low pressure section. Said pressure may be measured as suction pressure pₛ at the outlet of the evaporator. Thus, it may advantageously correspond to the pressure also utilized in the superheat control loop, which may be detected with sensor 48-pₛ. However, alternatively said pressure may be measured as low pressure pₗ at the evaporator inlet or it may be calculated from the low-pressure temperature Tₗ measured at the evaporator inlet, in which case said temperature may alternatively be considered the compressor controlled variable x_{c}(t). Measuring a temperature instead of a pressure may advantageously generally be cheaper in terms of component and assembly cost. However, temperature measurements in turn disadvantageously provide reduced measurement dynamics due to thermal inertia and an additional inaccuracy may be introduced due to neglecting any pressure loss across the evaporator 36. Thus, relying on a temperature measurement upstream of the evaporator may be particularly suitable for evaporators with a low loss of pressure. Similarly, a pressure may be measured upstream of the evaporator, which may advantageously be independent of thermal inertia. However, it may still not take into account any pressure loss across the evaporator. This may be particularly disadvantageous in cases where the pressure downstream of the evaporator is used in the superheat control loop.

A compressor control variable u_{c}(t) may comprise a rotational speed of the first compressor 30 and (if present) advantageously also of the second compressor. In other words, the compressor control variable u_{c}(t) may comprise the frequency of the first compressor 30, and if present, preferably the second compressor 31. In some embodiments, the compressor control variable u_{c}(t) may comprise a single rotational frequency for the compressor assembly, e.g. if on a single compressor is comprised by the compressor assembly, if the first and second compressor operate at the same rotational frequency or if the first and second compressor operate at rotational frequencies with a fixed ratio therebetween. Alternatively, the compressor control variable uc(t) may comprise a separate rotational frequency for the first compressor and the second compressor, e.g. chosen to allow for an equal mass flow. Using the frequency as compressor control variable u_{c}(t) allows to change the rotational speed of the respective compressor to ultimately change the pressure in the low-pressure section. Controlling the pressure in the low-pressure section may advantageously allow to affect the device temperature.

In embodiments comprising a two-staged compressor (i.e. embodiments wherein the compressor assembly comprises a first compressor and a second compressor), the first compressor and the second compressor may preferably be operated such that the mass flow rate may be equal. Advantageously, the first compressor 30 and the second compressor 31 may be reciprocating compressors. For a reciprocating compressor, the mass flow rate at a certain compressor speed/rotational frequency and a certain displacement volume depends on the gas pressure. Therefore, the mass flow rate at a certain compressor speed/rotational frequency and displacement volume may generally be higher for the second compressor 31 operating at a higher pressure than the first compressor 30 operating at a lower pressure. To achieve an approximately equal mass flow rate at the first compressor 30 and at the second compressor 31, the displacement volume at the first compressor 30 (low pressure side) may be chosen higher than the displacement volume at the second compressor 31 (high pressure side), if the first and the second compressor are operated at the same rotational frequency. The first compressor 30 and the second compressor 31 can be the first and the second stage of a two-stage compressor operating at the same frequency. To operate at the same rotational frequency the first and the second compressor may or may not be connected to a common driveshaft. Alternatively, to achieve an approximately equal mass flow rate, the first compressor 30 can be operated at a higher rational frequency than the second compressor 31. The first and the second compressor may or may not achieve the same mass flow rate at a certain rotational frequency. To achieve the same mass flow rate at a certain rotational frequency, the first and the second stage compressor may be of the same type or not. The ratio of the rotational frequency of first and the second compressor may be fixed and the first and the second compressor may be controlled using the same compressor control variable u_{c}(t), e.g. a single rotational frequency. Alternatively, the compressor speed/rotational frequency of first and the second compressor may be controlled independently, wherein the first compressor 30 may be controlled using the pressure at the outlet of the evaporator as a feedback variable, and the second stage compressor 31 may be controlled using a pressure in the intermediate stage between the first and the second compressor as a feedback variable.

Alternatively, equal mass flow rates of the first compressor and the second compressor may be achieved differently or the mass flow rate of the first compressor may be smaller than the mass flow rate of the second compressor.

A compressor reference variable w_{c}(t) may be a target pressure for the low-pressure section, e.g. p_{s,t}, which may advantageously be set based on a target device temperature T_{d,t}. In some embodiments, the target pressure for the low-pressure section may additionally be determined (and updated) based on the current device temperature. In such a case, the compressor control loop may be realized as a cascaded control loop. Wherein an offset for the target pressure may be determined based on the current device temperature, e.g. based on a difference between the current device temperature and the target device temperature. Additionally or alternatively, the target superheat SHₜ and the current superheat SH (based on measured values) may also be considered for determining the target pressure for the low-pressure section.

Thus, the compressor assembly may be operated based on the compressor control loop, which is configured for controlling a compressor controlled variable x_{c}(t) based on a compressor reference variable w_{c}(t) and a compressor feedback variable r_{c}(t). Operating the compressor assembly may particularly comprise modifying the mass flow rate of the compressor assembly and/or any compressor comprised by compressor assembly. That is, the compressor control variable u_{c}(t) may be determined based on an compressor error signal e_{c}(t) corresponding to the difference of the compressor reference variable and the compressor feedback variable: e_{c}(t)=w_{c}(t)−r_{c}(t). Subsequently the compressor assembly may be operated based on the compressor control variable u_{c}(t), e.g. run with the respective compressor frequency/frequencies. This may allow to stabilize the compressor controlled variable x_{c}(t) to the compressor reference variable w_{c}(t).

In other words, the controlled variable x_{c}(t) may be the pressure at the low-pressure section of the cooling circuit. The pressure can be measured at the outlet of the evaporator. An advantage of this sensor position may be that the pressure is equal to the suction pressure pₛ, which may be used in the superheat control loop. Alternatively, the low pressure pₗ can be measured at the evaporator inlet or the low pressure pₗ can be calculated from the low-pressure temperature Tₗ measured at the evaporator inlet and used as the controlled variable. An advantage of measuring the temperature at the evaporator inlet may be that temperature measurements are generally cheaper than pressure measurements in terms of component and assembly costs. However, this advantage may be offset by reduced measurement dynamics due to thermal inertia and additional inaccuracy due to the neglect of the pressure loss across the evaporator. This solution approach may be particularly suitable for evaporators with a low-pressure loss. A pressure measurement upstream of the evaporator may offer the advantage over temperature measurement that thermal inertia plays no role, but the pressure loss is also not taken into account. Failure to take the pressure loss into account can be a disadvantageous, especially when the pressure Pₛ is used in the superheat control loop at the same time. The pressure in the low-pressure section (e.g., pₛ or pₗ) may be used as controlled variable x_{c}(t) to control the rotational speed (control variable u_{c}(t)) of the first stage compressor (first compressor) and if present, advantageously also of the second stage compressor (second compressor). Advantageously, the first and the second compressor may be operated such that a capacity in terms of the mass flow rate of the first and the second compressor may be equal.

Thus, the present compressor control loop may advantageously allow for a frequency-controlled operation of the compressor assembly, which may advantageously allow to reduce or even prevent switching cycles of the compressor assembly, which may in turn reduce vibrations that may occur during on/off switching of the compressor assembly that may negatively impact samples placed inside the laboratory device, e.g. inside a rotor of a centrifuge.

With reference to FIG. 8, a bypass control loop may be provided for controlling the device temperature T_{d}, which may be measured within the laboratory device. For example, the device temperature may denote the temperature measured within the centrifuge vessel in case of the laboratory device being a centrifuge. That is, a bypass controlled variable x_{b}(t) of the bypass control loop may be the device temperature, which may be measured with the respective sensor 48-T_{d} to provide a bypass feedback variable r_{b}(t). A bypass control variable u_{b}(t) may be indicative of the valve position/opening degree of the bypass valve 47. The bypass control loop may be implemented as closed-loop control system, wherein a bypass reference variable w_{b}(t) may be a target device temperature T_{d}. The target device temperature may for example be specified by a user. Alternatively, the target device temperature may for example depend on a target sample temperature T_{p,t} for a sample placed within the device. For example, a user may provide a target device temperature or a target sample temperature through a graphical user input. In particular, the target value for the device temperature T_{d,t} may be determined based on the target sample temperature T_{p,t} and/or additional operational parameters like the rotor type and the rotor speed (rotational frequency of the rotor), and preferably on the (measured) ambient temperature as for example described elsewhere in this application. The additional operational parameters may be provided by a user similar to the target sample temperature. Alternatively, a respective desired temperature may be derived from a method performed by the laboratory device. In other words, the bypass controlled variable of the bypass control loop may be the device temperature T_{d} measured within the device, e.g. within the centrifuge vessel. The device temperature may be used as bypass controlled variable x_{b}(t) to control the opening degree of the bypass valve 47.

Thus, bypass valve may be operated based on the bypass control loop, which is configured for controlling the bypass controlled variable x_{b}(t) based on the bypass reference variable w_{b}(t) and the bypass feedback variable r_{b}(t). Operating the bypass valve may particularly comprise modifying an opening degree of the bypass valve. In particular, the bypass control variable u_{b}(t) may be determined based on a bypass error signal e_{b}(t) corresponding to the difference of the bypass reference variable and the bypass feedback variable: e_{b}(t)=w_{b}(t)−r_{b}(t). Subsequently, the bypass vlave may be operated based on the bypass control variable u_{b}(t) to affect the bypass controlled variable x_{b}(t), e.g. the opening degree of the bypass valve may be set to a value determined by the controller. This may allow to stabilize the bypass controlled variable x_{b}(t) to the bypass reference variable w_{b}(t).

Generally, the hot-gas bypass may advantageously allow to provide heat to the evaporator and thus when controlled by a respective bypass control loop, the compressor assembly may advantageously not need to be switched off even when the device temperature may for example be too low and it may advantageously generally extend the range of application for the laboratory device and/or the cooling system. For example, in case of a centrifuge, the hot-gas bypass may allow heating of the rotor chamber (also referred to as centrifuge chamber), which may advantageously allow for a wider range of applications and also may allow to keep the compressor assembly running (i.e. reduce or prevent switching cycles of the compressor assembly).

Overall, the present invention and particularly a combination of the disclosed control loops may allow to adapt the cooling system based on the current thermal load and may particularly allow to achieve a better stabilization of the device temperature (and consequently the sample temperature) in that a maximum and minimum deviation from the target device temperature may be reduced. Furthermore, the present cooling system may advantageously allow use of CO₂ as refrigerant, which reduces negative impacts on the environment compared to other refrigerants.

In one aspect, the present invention may relate to a combination of the compressor control loop and the bypass control loop, wherein the two control loops are coupled. In the following this aspect is further explained with regard to a system comprising only a compressor assembly comprising a single (first) compressor, however, it will be understood that the system may advantageously comprise a compressor assembly comprising a first compressor and a second compressor in which case the compressor control loop may me modified as explained above.

Very generally, the device temperature T_{d} and the pressure of the low-pressure section pₛ (or pₗ) may be used as controlled variables and feedback variables in order to control the bypass valve 47 and the compressor assembly. In particular, the bypass control loop and the compressor control loop may be coupled by additionally also considering the current device temperature for determining the compressor reference variable w_{c}(t) of the compressor control loop. In particular, a ratio between the measured (current) device temperature and the target device temperature T_{d,t} may be considered for modifying the reference variable of the compressor control loop. Such a coupling of the two control loops may allow to avoid contradictory or competing control actions between the two control loops and may overall improve speed and accuracy of controlling the device temperature and the refrigerant pressure in the low-pressure section.

Alternatively, the device temperature may be used as compressor controlled variable x_{c}(t) and the current device temperature may be used as compressor reference variable r_{c}(t) for the compressor control loop. In other words, in the compressor control loop the speed/rotational frequency of the first compressor (and optionally the second compressor) may be controlled using the device temperature T_{d} within the device (e.g., centrifugation/rotor chamber) or evaporator as the compressor controlled variable. At the same time, the bypass control loop may control the bypass valve 47 using the pressure of the low-pressure section as bypass controlled variable. The control loops may then be coupled by modifying the target pressure (i.e. the bypass reference variable for the pressure) by the actual measured device temperature, e.g. by a ratio between the actual, measured device temperature and the target device temperature.

In yet another alternative embodiment, the bypass control loop may control the bypass valve based on the pressure in the low-pressure section as bypass controlled variable x_{b}(t), while the bypass reference variable for the pressure (i.e., the target variable) may be modified by the actual measured value of the device temperature, e.g. by a ratio between the actual, measured device temperature and the desired device temperature. Similarly, the compressor control loop may control the speed/rotational frequency of the compressor assembly using the pressure of the low-pressure section as compressor controlled variable x_{c}(t). Again, the compressor reference variable for the pressure (i.e., the target value) may be modified by the actual measured value of the device temperature, e.g. by a ratio between the actual, measured device temperature and the desired device temperature. That is both control loops may use the same reference variable w(t).

Furthermore, both control loops may use the device temperature, i.e. the temperature in the device (or evaporator), e.g. in the centrifugation chamber, as controlled variable, thereby coupling the two control loops.

In another aspect, the present invention relates to a method for determining an initial value for at least one actuator of a control loop in a cooling system, particularly the compressor control loop and the bypass control loop, but optionally also for the high-pressure control loop, the superheat control loop and the cooling-device control loop.

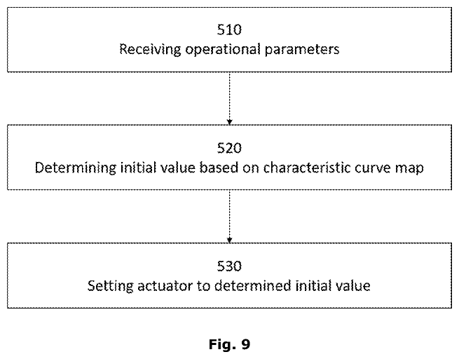

With reference to FIG. 9, the method may generally comprise the steps of receiving operational parameters (step 510), determining, preferably automatically, the initial value for at least one actuator using a characteristic curve map to map at least some of the operational parameters to an initial value for the at least one actuator (step 520), and setting, preferably automatically, the at least one actuator to the respective initial value (step 530). That is, at least a portion of the operational parameters may be taken as input for a characteristic curve map to determine a respective initial value. Thus, the at least one initial value may be determined based on a characteristic curve map. The characteristic curve map may be actuator-specific.

The operational parameters may for example be received from a user. That is, a user may provide operational parameters for example via a user interface. Additionally, or alternatively operational parameters may automatically be determined based on an automated workflow. For example, components of the laboratory device may be identified using automated identification procedures. An operational parameter may also be determined, e.g. calculated, based on other operational parameters.

Generally, operational parameters may for example comprise an ambient temperature of the laboratory device, a target device temperature and/or a target sample temperature. Typically, a user may specify a target sample temperature since said temperature may be most relevant to the user. However, the user can for example also provide a target device temperature. Alternatively, the target device temperature may be determined, e.g. calculated, based on the target sample temperature and further operational parameters.

The target device temperature may be determined, preferably automatically, based on one or more of the operational parameters. For example, the target device temperature T_{d,t} may depend on the ambient temperature Tₐ, the target sample temperature T_{p,t} and/or an amount of heat generated by the device when running. The amount of generated heat may also be determined, preferably automatically, based on the operational parameters. The target device temperature may be determined based on one or more of the operational parameters using a characteristic curve map.

In case of the laboratory device being a centrifuge, the operational parameters may further comprise a rotor type and/or rotational frequency of the rotor. Additionally, the operational parameters may comprise a target vacuum pressure in case the laboratory device is a vacuum centrifuge.

Determining an initial value for at least one actuator of the cooling system may again preferably performed automatically. In particular a characteristic curve map may be used to automatically determine an initial value for at least one actuator based on the operational parameters. In other words, the initial values for the actuators may be determined using characterization curve maps (“Kennlinienfelder”) that predefine a multidimensional mapping of operation parameters for the laboratory device to initial values of actuators of the control loops.

Operational parameters may be provided by a user prior to operating the laboratory device or determined based on a choice of configuration of the laboratory device (e.g. by selecting a particular rotor for a centrifuge). Some operational parameters may be determined based on other operational parameters (e.g. the target device temperature).

The initial values for the actuators may be determined (e.g. re-calculated) each time the laboratory device is operated, or determined for a plurality of operations with equal parameters.

Finally, the actuators may be set to the initial values, e.g. when starting the cooling system. Presetting the actuators to initial values may generally advantageously significantly shorten and ideally minimize stabilization time for respective control loops. Presetting the actuators to respectively determined initial values in accordance with the present invention may additionally advantageously allow to significantly shorten the stabilization time even when using a slower controller within the control loops. Using a slower controller for controlling the actuators in the control loops may advantageously allow to use components having a lager thermal inertia and/or being simpler to manufacture. For example, an evaporator with a large cooling capacity and only a single injection point may generally comprise a high thermal inertia compared to a compressor with lower cooling capacity and/or multiple injection points and/or be simpler to manufacture. Thus, a multipoint evaporator comprising multiple injection points for evaporation of the refrigerant may advantageously not be needed.

The method may particularly relate to determining an initial value for the compressor control loop and/or the bypass control loop. The actuator of the bypass control loop may be the bypass valve 47 and the initial value determined for the bypass valve 47 may be its valve position/opening degree. The actuator of the compressor control loop may be the (first) compressor and optionally also the second compressor. The initial value determined for the compressor(s) may be the rotational frequency (i.e. the speed) of the compressor. Again, in case of two-staged compression the initial value may be determined separately, e.g. independently, for the first and second compressor, or a common initial value may be determined if the first and second compressor, e.g. if they operate at the same rotational frequency or at a fixed ratio of rotational frequencies.

Furthermore, the method may also relate to determining and initial values for the superheat control loop. In this case, the actuator may be the expansion device 34 and the initial value determined for the expansion device 34 may be an opening degree of the expansion valve, e.g. a valve position.

The method may also relate to determining an initial value for the cooling-device control loop, wherein the actuator may be a device providing a fluid flow for transporting heat away from the cooling device, preferably a fan. The initial value may then relate to the rate at which such fluid is supplied, preferably the fan speed/frequency.

The method may also relate to determining an initial value for the high-pressure control loop, wherein the actuator may be the high-pressure control valve 42 and the initial value may relate to the valve position/opening degree of the high-pressure control valve.

Determining designated initial values for actuators based on operational parameters for a planned operation of the laboratory device may advantageously allow to speed up stabilization of the cooling system to the respective target values compared to utilizing fixed initial values independent on the current operational parameters.

In other words, an aspect of the present invention can be seen in defining/determining initial values for actuators of the disclosed control loops, particularly the compressor control loop and the bypass control loop (but advantageously also the high-pressure control loop, the cooling-device control loop, and setting the actuators according to the determined initial values. Actuators of the control loops may generally comprise the expansion device 34, the high-pressure control valve 42, the bypass valve 47 in the hot-gas bypass 46, the fluid supply for the cooling device (preferably the fan), and/or the compressor(s). Thus, initial values may relate to valve positions, ore respectively opening degree of the high-pressure control valve, the bypass valve and/or the expansion device, a fan speed in case the cooling device is air-cooled, and/or a compressor speed, or respectively a rotational frequency of the compressor. That is, one compressor speed in the case of one-stage compression, and in embodiments comprising two-stage compression, compressor speed of the first and the second compressor, which may be defined independently, or by a common variable, if the first and the second compressor are operated at a certain predetermined ratio of the compressor speed/rotational frequency.

For example, if the laboratory device is a centrifuge and the cooling system is configured to cool the centrifuge chamber, operational parameters may comprise a rotor type, a target rotational frequency of the rotor (or rotation speed of the rotor, respectively, the ambient temperature (e.g. room temperature), the target sample temperature T_{p,t}, and/or in case of a vacuum centrifuge a target vacuum pressure. Again, based on these operational parameters the initial values for the actuators may be determined for starting/initiating the control loops. Said operational parameters may be provided by a user at the beginning of the centrifugation operation or determined based on a choice of configuration of the centrifuge, e.g. by selecting a particular rotor. The rotor type can for example be determined based on an automated workflow, e.g. automated rotor identification through the centrifuge.

In particular, a desired device temperature may be determined based on these operational parameters. In particular, the target sample temperature T_{p,t} may be translated into a target device temperature T_{d,t} by taking into account the operational parameters to determine a respective correction. This may allow to take into account heat generated during processing of the sample, i.e. rotating the sample in the centrifuge, as well as an influence of the ambient temperature on the process. The target device temperature may then be used as reference variable for the bypass control loop and potentially also for determining the reference variable for the compressor control loop. Furthermore, the target device temperature may also be considered for determining the reference variable of the superheat control loop. However, the operational parameters and the based thereon determined target device temperature may in particular allow to determine initial variables for the actuators of control loops comprised by the system.

In other words, the rotor type (and optionally for a vacuum centrifuge the vacuum pressure) may define a drag coefficient describing the friction of the rotor. The drag coefficient and the rotational frequency of the rotor may in combination determine the amount of heat generated by the friction of the rotor. Thus, the amount of heat generated during operation may be determined based on the operational parameters. The amount of heat generated by friction within a certain time interval for a particular rotor (rotor power) may, advantageously in combination with the ambient temperature (e.g. room temperature), determine how a certain temperature of the centrifuge chamber (i.e. device temperature T_{d}) may translate into a sample temperature Tₚ (i.e. temperature of a sample to be centrifuged). Said sample temperature may be important from an application perspective and the target sample temperature T_{p,t} may advantageously be provided to the system by a user, e.g. using a user interface. Alternatively, the target sample temperature T_{p,t} may be pre-defined for a particular workflow for processing a sample to be centrifuged. The target sample temperature may then be translated into the target device temperature, i.e. a target value for the temperature of the centrifuge chamber, by considering a correction value that may depends on the room temperature, rotation speed, and rotor type.

The determined targe device temperature may for example additionally or alternatively serve to determine at least one reference value for control loops.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, a preferred embodiment has been described with reference to the accompanying drawings, the skilled person will understand that this embodiment was provided for illustrative purpose only and should by no means be construed to limit the scope of the present invention, which is defined by the claims.

1. A method for operating a cooling system of a laboratory device, wherein the cooling system comprises:
a compressor assembly, comprising at least a first compressor;
a cooling device;
an expansion device; and
an evaporator;
which are fluidly connected to form a main cycle; and
wherein the cooling system further comprises a refrigerant circulating through the main cycle;
the method comprising operating the compressor assembly based on a compressor control loop for controlling a compressor controlled variable x_{c}(t) based on a compressor reference variable w_{c}(t) and a compressor feedback variable r_{c}(t); and
the method further comprising operating the expansion device based on a superheat control loop for controlling a superheat controlled variable xₛ(t) based on a superheat reference variable wₛ(t) and a superheat feedback variable rₛ(t).

2. The method according to claim 1, wherein the cooling system further comprises a hot-gas bypass comprising a bypass valve, wherein the hot-gas bypass fluidly connects to the main cycle at a connection point upstream of the cooling device and downstream of the compressor assembly and at a connection point upstream of the evaporator and downstream of the expansion device, the method further comprising:
operating the bypass valve based on a bypass control loop for controlling a bypass controlled variable x_{b}(t) based on a bypass reference variable w_{b}(t) and a bypass feedback variable r_{b}(t).

3. The method according claim 1, wherein the method comprises determining an initial value for at least one actuator of a control loop.

4. The method according to claim 3, wherein determining an initial value for at least one actuator comprises:
receiving operational parameters;
determining the initial value for at least one actuator using a characteristic curve map to map at least some of the operational parameters to an initial value for the at least one actuator; and
setting the at least one actuator to the respective initial value.

5. The method according to claim 4, wherein the operational parameters comprise an ambient temperature, a target device temperature and/or a target sample temperature.

6. The method according to claim 5, wherein the method further comprises determining the target device temperature T_{t,d} based on the operational parameters.

7. The method according to claim 4, wherein the laboratory device is a centrifuge, and wherein the operational parameters comprise a rotor type and/or a rotational frequency of the rotor.

8. The method according to claim 3, wherein the at least one actuator comprises the compressor assembly acting as actuator for the compressor control loop, and wherein the respective initial value comprises at least one compressor frequency.

9. The method according to claim 3, wherein the at least one actuator comprises the bypass valve acting as actuator for the bypass control loop, and wherein the respective initial value comprises an initial opening degree for the bypass valve.

10. The method according to claim 4, wherein the characteristic curve map used is actuator dependent.

11. The method according to claim 2, wherein the method comprises coupling the compressor control loop and the bypass control loop.

12. The method according to the claim 11, wherein:
the compressor reference variable w_{c}(t) is a target pressure of the low-pressure section, a target suction pressure p_{s,t} or a target low pressure pₗ; and
the bypass reference variable w_{b}(t) is a target device temperature T_{d,t} within the laboratory device;
wherein the target pressure of the low-pressure section, the target suction pressure p_{s,t} or the target low pressure pₗ is determined based on a current device temperature within the laboratory device which also serves as bypass feedback variable r_{b}(t).
